(19) United States
(12) Patent Application Publication
(10) Pub. No.: US 2023/0262852 A1
(43) Pub. Date: Aug. 17, 2023

(54) SPLATTER COVER AND APPARATUS FOR CREATING MOISTURE FOR FOODS DURING USE IN MICROWAVE OVENS

(71) Applicant: Glen E. Kotapish, Fredericksburg, VA (US)

(72) Inventor: Glen E. Kotapish, Fredericksburg, VA (US)

(21) Appl. No.: 18/132,002

(22) Filed: Apr. 7, 2023

Related U.S. Application Data
(63) Continuation-in-part of application No. 17/460,148, filed on Aug. 27, 2021.

(51) Int. Cl. H05B 6/64; A47J 36/02

(52) U.S. Cl. CPC H05B 6/6408; A47J 36/027

(57) ABSTRACT

One aspect of the present invention is a splatter cover for minimizing or preventing food and drink splatters inside microwave ovens. Another aspect is a splatter cover having at least one water reservoir for minimizing or preventing food and drink splatters and also for creating moisture for foods during use inside a microwave oven. A further aspect is a securing or mounting device having at least one water reservoir. An additional aspect is a splatter cover having at least one butter reservoir. The splatter cover may be manufactured of one or more pieces or sections. Another aspect is a splatter cover apparatus that includes a splatter cover and at least one securing device. In general, the splatter cover and splatter cover apparatus are preferably left in place inside the microwave oven after use and when the microwave oven is not in use.

### CROSS-REFERENCE TO RELATED APPLICATIONS

The present application claims the priority benefit of U.S. Nonprovisional patent application Ser. No. 17/460,148, filed on Aug. 27, 2021 and titled “SPLATTER COVER AND APPARATUS FOR USE IN MICROWAVE OVENS,” which is incorporated herein by reference in its entirety.

### BACKGROUND OF THE INVENTION

### Field of the Invention

The present invention generally relates to covers, devices, apparatuses, and systems for minimizing or preventing food and drink splatters during use inside microwave ovens and also relates to covers, devices, apparatuses, and systems for creating moisture for foods during use inside microwave ovens. More specifically, one aspect of the present invention is a splatter cover for minimizing or preventing food and drink splatters during use inside a microwave oven. Another aspect of the present invention is an apparatus that includes a splatter cover and a securing or mounting device for minimizing or preventing food and drink splatters during use inside a microwave oven. A further aspect of the present invention is a splatter cover having at least one water reservoir for minimizing or preventing food and drink splatters and also for creating moisture for foods during use inside a microwave oven. An additional aspect of the present invention is a securing or mounting device having at least one water reservoir for creating moisture for foods during use inside a microwave oven. Another aspect of the present invention is an apparatus that includes a splatter cover and a securing or mounting device wherein at least one of them has at least one water reservoir for creating moisture for foods during use inside a microwave oven. In general, the splatter cover of the present invention may be left in place inside the microwave oven after use and when the microwave oven is not in use.

### Description of the Related Art

Covers, devices, apparatuses, and systems for minimizing or preventing food and drink splatters during use inside microwave ovens are known in the art.

Covers, devices, apparatuses, and systems for creating moisture for foods during use inside microwave ovens may be or may not be known in the art.

The present invention overcomes one or more of the shortcomings of covers, devices, apparatuses and systems for minimizing or preventing food and drink splatters during use inside microwave ovens and, if applicable, of covers, devices, apparatuses and systems for creating moisture for foods during use inside microwave ovens. The Applicant is unaware of inventions or patent documents, taken either singly or in combination, which are seen to describe the present invention as claimed.

One advantage of the present invention, once the splatter cover of the present invention has been attached, secured or mounted inside a microwave oven, is that it allows for a user of the microwave oven to avoid touching or handling the splatter cover prior to use, unless for washing or cleaning of the splatter cover, or for changing the height position, lateral or side-to-side position, and/or forward-to-rearward position of the splatter cover with respect to the position(s) of the microwave oven turntable plate, bottom side of the microwave oven, and/or food or drink container. This advantage may be especially beneficial to kids, young people, elderly people, handicap people, people who cannot do too many functions, and people who want or need to simplify the use of a microwave oven.

Another advantage of the present invention is that it helps to keep the microwave oven itself and/or the area in proximity of the microwave oven more clean, neat and/or tidy since the splatter cover of the present invention may be positioned or stored inside the microwave oven most or all of the time, unless for cleaning or washing, after use without having the need for the user or someone else thinking or remembering where to store the splatter cover.

A further advantage of the present invention, when the present invention is an apparatus that includes at least one securing or mounting device, is that it allows for the use or operational position of the splatter cover to be adjustable with regard to height position, lateral or side-to-side position, and/or forward-to-rearward position of the splatter cover with respect to the position(s) of the microwave oven turntable plate, bottom side of the microwave oven, and/or food or drink container such that a single splatter cover can generally be effectively used inside microwave ovens having interior spaces of different heights, lengths, widths, and/or shapes and can generally be effectively used with plates, cups, and/or food or drink containers of different lengths, widths, heights, and/or shapes.

An additional advantage of the present invention is that it may help to prevent the splatter cover of the present invention from being misplaced, lost, or difficult to find.

Another advantage of the present invention is that it may help to keep the splatter cover of the present invention from accumulating dust or getting dirty from the surrounding environment when compared to splatter covers that are positioned or stored outside the microwave oven.

A further advantage of the present invention is that a two-piece, splatter cover of the present invention may be simpler and/or less costly to manufacture, store, package, and/or ship when compared to certain splatter covers known in the art, such as one-piece covers having a larger diameter than the diameter of a single piece or section of the two-piece, splatter cover (wherein the two pieces or sections can be stacked on top of one another for storing, packaging, and/or shipping) of the present invention and also such as covers that include or contain magnet(s) embedded in or secured to the cover.

An additional advantage of the present invention is that various alternative securing or mounting devices, such as, but not limited to, suctions or suction cups or at least one magnet, of the present invention can be moved upward and downward (for height adjustment), rightward and leftward (for lateral adjustment), and/or forward and rearward (for width adjustment) to particular securing or mounting points on a securing or mounting side or wall of a microwave oven to adjust to and to accommodate the different heights, lengths, widths, and/or shapes of plates, cups, and/or food or drink containers.

Another advantage of the present invention is providing a splatter cover having at least one water reservoir so as to minimize or prevent food and drink splatters and also to provide or add moisture to foods during use inside a microwave oven.

A further advantage of the present invention is providing a securing or mounting device having at least one water reservoir so as to provide or add moisture to foods being microwaved.

An additional advantage of the present invention is providing an apparatus having a splatter cover and a securing or mounting device wherein at least one of them has at least one water reservoir so as to minimize or prevent food and drink splatters and also to provide or add moisture to foods during use inside a microwave oven.

Another advantage of the present invention is providing a splatter cover having at least one butter reservoir so as to minimize or prevent food and drink splatters and also to provide or add butter to foods during use inside a microwave oven.

An additional advantage of the present invention is providing an apparatus having a splatter cover that has at least one butter reservoir so as to minimize or prevent food and drink splatters and also to provide or add butter and/or other meltable food products to foods during use inside a microwave oven.

### SUMMARY OF THE INVENTION

One aspect of the present invention is a splatter cover for minimizing or preventing food and drink splatters during use inside microwave ovens. The splatter cover may be a one-piece, splatter cover, a two-piece, splatter cover, or a splatter cover made or manufactured of more than two pieces or sections. Another aspect of the present invention is a splatter cover apparatus that includes a splatter cover and at least one securing or mounting device for minimizing or preventing food and drink splatters inside microwave ovens. When the splatter cover is a two-piece, splatter cover or a splatter cover made or manufactured of more than two pieces, then it's preferred that the splatter cover apparatus includes both the first securing or mounting device and second securing or mounting device. In general, the splatter cover and splatter cover apparatus are preferably left in place inside the microwave oven after use and when the microwave oven is not in use.

With regard to the different embodiments of the present invention where the splatter cover is a two-piece, splatter cover or splatter cover made or manufactured of more than two pieces or sections, each of the first cover section and second cover section may have various dimensions and configurations to complement the dimensions and configurations of one another such that, preferably prior to operation but, alternatively, could be soon after operation initiation, the first cover section and second cover section are initiated for operation by the user, such as, but not limited to, when the door of the microwave oven goes from the open position to the closed position by the user closing the door, to come together or toward one another to operationally form the two-piece, splatter cover or splatter cover made or manufactured of more than two pieces or sections and partially, substantially, or entirely surround and/or cover the food, drink, and/or food or beverage container, vessel, heating element, or retaining device to minimize or prevent splatters during microwave oven operation.

Another aspect of the present invention is a splatter cover having at least one water reservoir for minimizing or preventing food and drink splatters and also for creating moisture for foods during use inside a microwave oven.

A further aspect of the present invention is a securing or mounting device having at least one water reservoir for creating moisture for foods during use inside a microwave oven.

An additional aspect of the present invention is an apparatus that includes a splatter cover and a securing or mounting device wherein at least one of them has at least one water reservoir for minimizing or preventing food and drink splatters and also for creating moisture for foods during use inside a microwave oven.

Another aspect of the present invention is a splatter cover having at least one butter reservoir so as to minimize or prevent food and drink splatters and also to provide or add butter and/or other meltable food products to foods during use inside a microwave oven.

An additional aspect of the present invention is an apparatus having a splatter cover that has at least one butter reservoir so as to minimize or prevent food and drink splatters and also to provide or add butter and/or other meltable food products to foods during use inside a microwave oven.

### BRIEF DESCRIPTION OF THE DRAWINGS

FIG. 1 is a perspective view of a first embodiment of a splatter cover apparatus according to the present invention, wherein the apparatus includes a two-piece splatter cover and securing or mounting devices;

FIG. 2 is a perspective view of one cover section of the two-piece splatter cover of FIG. 1;

FIG. 3 is a side view of the one cover section of FIG. 2;

FIG. 4 is a front view of the one cover section of FIG. 2;

FIG. 5 is a perspective, rear, bottom view of the one cover section of FIG. 2;

FIG. 6 is a bottom view of the one cover section of FIG. 2;

FIG. 7 is a perspective, front, bottom view of the one cover section of FIG. 2;

FIG. 8 is a perspective, front, top view of the one cover section of FIG. 2, with a different securing or mounting device;

FIG. 9 is a perspective, front, top view of the one cover section of FIG. 2, with another different securing or mounting device (in a first securing or mounting orientation);

FIG. 10 is a perspective, front, top view of the one cover section of FIG. 2, with the different securing or mounting device of FIG. 9 (in a second securing or mounting orientation);

FIG. 11 is an environmental, perspective view of a second embodiment of a splatter cover apparatus according to the present invention, wherein the apparatus includes a two-piece splatter cover and securing or mounting devices, and wherein the door and top of a microwave oven have been removed for better viewing;

FIG. 12 is an environmental, top view of the splatter cover apparatus of FIG. 11, wherein the door of the microwave oven is in an open position, and wherein the top of the microwave oven has been removed for better viewing;

FIG. 13 is an environmental, top view of the splatter cover apparatus of FIG. 11, wherein the door of the microwave oven is in a closed position for use or operation, and wherein the top of the microwave oven has been removed for better viewing;

FIG. 14 is a perspective view of a non-limiting example of a securing or mounting device;

FIG. 15a is a perspective view of another non-limiting example of a securing or mounting device;

FIGS. 15b-15e are perspective views of different replaceable securing or mounting components or features of the securing or mounting device of FIG. 15a;

FIG. 16 is a perspective view of a further non-limiting example of a securing or mounting device;

FIG. 17 is a perspective view of another non-limiting example of a securing or mounting device;

FIG. 18 is a perspective view of a further non-limiting example of a securing or mounting device;

FIG. 19 is a perspective view of another non-limiting example of a securing or mounting device;

FIG. 20 is a perspective view of a further non-limiting example of a securing or mounting device;

FIG. 21 is a perspective view of a third embodiment of a splatter cover apparatus according to the present invention, wherein the apparatus includes a two-piece splatter cover and securing or mounting devices;

FIG. 22 is a perspective, rear view of one cover section of the two-piece splatter cover of FIG. 21, with a different securing or mounting device (in a first securing or mounting orientation);

FIG. 23 is a perspective, front view of the one cover section of FIG. 21, with the different securing or mounting device of FIG. 22 (in a second securing or mounting orientation);

FIG. 24 is an environmental, top view of the splatter cover apparatus of FIG. 21, wherein the door of the microwave oven is in a closed position for use or operation, and wherein the top of the microwave oven has been removed for better viewing;

FIG. 25 is a perspective view of a fourth embodiment of a splatter cover apparatus according to the present invention, wherein the apparatus includes a two-piece splatter cover and securing or mounting devices;

FIG. 26 is a rear view of the splatter cover apparatus of FIG. 25;

FIG. 27 is a top view of the splatter cover apparatus of FIG. 25;

FIG. 28 is a top view of a larger cover section of the splatter cover apparatus of FIG. 25;

FIG. 29 is a perspective, front, top view of the larger cover section of the splatter cover apparatus of FIG. 25;

FIG. 30 is a front view of the larger cover section of the splatter cover apparatus of FIG. 25;

FIG. 31 is a side view of the larger cover section of the splatter cover apparatus of FIG. 25;

FIG. 32 is a perspective, front, top view of a smaller cover section of the splatter cover apparatus of FIG. 25;

FIG. 33 is an environmental, perspective view of the splatter cover apparatus of FIG. 25, wherein the door of the microwave oven is in an open position;

FIG. 34 is a perspective view of a fifth embodiment of a splatter cover apparatus according to the present invention, wherein the apparatus includes a four-piece splatter cover and securing or mounting devices;

FIG. 35 is a top view of the splatter cover apparatus of FIG. 34;

FIG. 36 is a bottom view of the splatter cover apparatus of FIG. 34;

FIG. 37 is an end view of the splatter cover apparatus of FIG. 34;

FIG. 38 is a side view of the splatter cover apparatus of FIG. 34;

FIG. 39 is a perspective, end, top view of one cover section and one extension of FIG. 34;

FIG. 40 is a perspective, front, top view of one cover section with another non-limiting example of a securing or mounting device;

FIG. 41 is a perspective, front, bottom view of the one cover section and securing or mounting device of FIG. 40;

FIG. 42 is a side view of the one cover section and securing or mounting device of FIG. 40;

FIG. 43 is a bottom view of the one cover section and securing or mounting device of FIG. 40;

FIG. 44 is a front view of the one cover section and securing or mounting device of FIG. 40;

FIG. 45 is a perspective view of a sixth embodiment of a splatter cover apparatus according to the present invention, wherein the apparatus includes a one-piece splatter cover and a securing or mounting device;

FIG. 46 is an environmental, perspective view of the splatter cover apparatus of FIG. 45, wherein the splatter cover is in a raised position relative to a food container, wherein the door of a microwave oven is in an open position, and wherein the top of the microwave oven has been removed for better viewing;

FIG. 47 is an environmental, perspective view of the splatter cover apparatus of FIG. 45, wherein the splatter cover is in a lowered position relative to a food container, wherein the door of a microwave oven is in an open position, and wherein the top of the microwave oven has been removed for better viewing;

FIG. 48 is an environmental, perspective view of a seventh embodiment of a splatter cover apparatus according to the present invention, wherein the apparatus includes a one-piece splatter cover, a securing or mounting device, and a stopper, wherein the door of a microwave oven is in an open position, and wherein the top of the microwave oven has been removed for better viewing;

FIG. 49 is an environmental, perspective view of the splatter cover apparatus of FIG. 48, wherein the splatter cover is engaged underneath the stopper, wherein the door of a microwave oven is in a closed or operating position. and wherein the top of the microwave oven has been removed for better viewing;

FIG. 50 is an environmental, side cut-away view of the splatter cover apparatus of FIG. 48, wherein the splatter cover is engaged underneath the stopper, and wherein the door of a microwave oven is in a closed or operating position;

FIG. 51 is a perspective view of a non-limiting example of a securing or mounting device;

FIG. 52 is a perspective view of the securing or mounting device of FIG. 51;

FIG. 53 is a perspective view of another embodiment of a first section/half (or, alternatively, a second section/half) of a two-piece, splatter cover apparatus according to the present invention, wherein each section/half of the apparatus includes one cover section (a first cover section or, alternatively, a second cover section) of a two-piece splatter cover and one sliding securing or mounting device (both are shown in an engaged position);

FIG. 54 is a perspective, bottom, right side view of the first section/half (or alternatively, the second section/half) of the two-piece, splatter cover apparatus of FIG. 53;

FIG. 55 is a perspective, front, right side view of the first cover section (or alternatively, the second cover section) of FIG. 53;

FIG. 56 is a perspective, front, right side view of the sliding securing or mounting device of FIG. 53;

FIG. 57 is a top view of an embodiment of a two-piece, splatter and moisture-creating cover apparatus according to the present invention, wherein each section/half of the apparatus includes one cover section (a first cover section or, alternatively, a second cover section) of a two-piece splatter and moisture-creating cover and one sliding securing or mounting device (both are shown in an engaged position);

FIG. 58 is a perspective, front, right side view of the first section/half (or alternatively, the second section/half) of the splatter and moisture-creating cover apparatus of FIG. 57, shown in a disengaged position;

FIG. 59 is a perspective, front, right side view of the first section/half (or alternatively, the second section/half) of the splatter and moisture-creating cover apparatus of FIG. 57, shown in an engaged position (such as inside a smaller microwave oven);

FIG. 60 is a perspective, front, right side view of the first section/half (or alternatively, the second section/half) of the splatter and moisture-creating cover apparatus of FIG. 57, shown in an engaged position (such as inside a larger microwave oven);

FIG. 61 is a perspective, rear, left side view of the first cover section (or alternatively, the second cover section) of FIG. 57;

FIG. 62 is a perspective, bottom, front, right side view of the first cover section (or alternatively, the second cover section) of FIG. 57;

FIG. 63 is a perspective, front, right side view of the sliding securing or mounting device of FIG. 57;

FIG. 64 is a perspective, rear, left side view of the sliding securing or mounting device of FIG. 57;

FIG. 65 is a perspective, bottom, front, left side view of the sliding securing or mounting device of FIG. 57;

FIG. 66 is an environmental, perspective view of the splatter and moisture-creating cover apparatus of FIG. 57, shown in an engaged position inside a microwave oven (with a top removed for easier viewing) and the two sections/halves of the two-piece splatter and moisture-creating cover being adjacent to one another during use or in position for use;

FIG. 67 is an environmental, top, perspective view of the splatter and moisture-creating cover apparatus of FIG. 57, shown in an engaged position inside a microwave oven (with a top removed for easier viewing) and the two sections/halves of the two-piece splatter and moisture-creating cover being adjacent to one another during use or in position for use;

FIG. 68 is an environmental, perspective view of the splatter and moisture-creating cover apparatus of FIG. 57, shown in an engaged position inside a microwave oven (with a top removed for easier viewing) and the two sections/halves of the two-piece splatter and moisture-creating cover being separated from one another and not ready for use;

FIG. 69 is an environmental, top, perspective view of the splatter and moisture-creating cover apparatus of FIG. 57, shown in an engaged position inside a larger-sized microwave oven (with a top removed for easier viewing) and the two sections/halves of the two-piece splatter and moisture-creating cover being adjacent to one another during use or in position for use;

FIG. 70 is an environmental, top view of the splatter and moisture-creating cover apparatus of FIG. 57, shown in an engaged position inside a microwave oven (with a top removed for easier viewing) and the two sections/halves of the two-piece splatter and moisture-creating cover being adjacent to one another during use or in position for use;

FIG. 71 is an environmental, top view of the splatter and moisture-creating cover apparatus of FIG. 57, shown in an engaged position inside a larger-sized microwave oven (with a top removed for easier viewing) and the two sections/halves of the two-piece splatter and moisture-creating cover being adjacent to one another during use or in position for use;

FIG. 72 is a perspective, rear, left side view of the first cover section (or alternatively, the second cover section) of FIG. 57, wherein a pair of reservoir covers are additionally included;

FIG. 73 is a perspective, front, right side view of the sliding securing or mounting device of FIG. 57, wherein a reservoir cover is additionally included; and

FIG. 74 is a perspective, front right side view of a first cover section (or alternatively, a second cover section) of a two-piece, splatter and moisture-creating cover according to the present invention, wherein the cover section includes a water reservoir and a butter reservoir.

It should be understood that the above-attached figures are not intended to limit the scope of the present invention in any way.

### DETAILED DESCRIPTION OF THE EMBODIMENTS AND ASPECTS OF THE PRESENT INVENTION

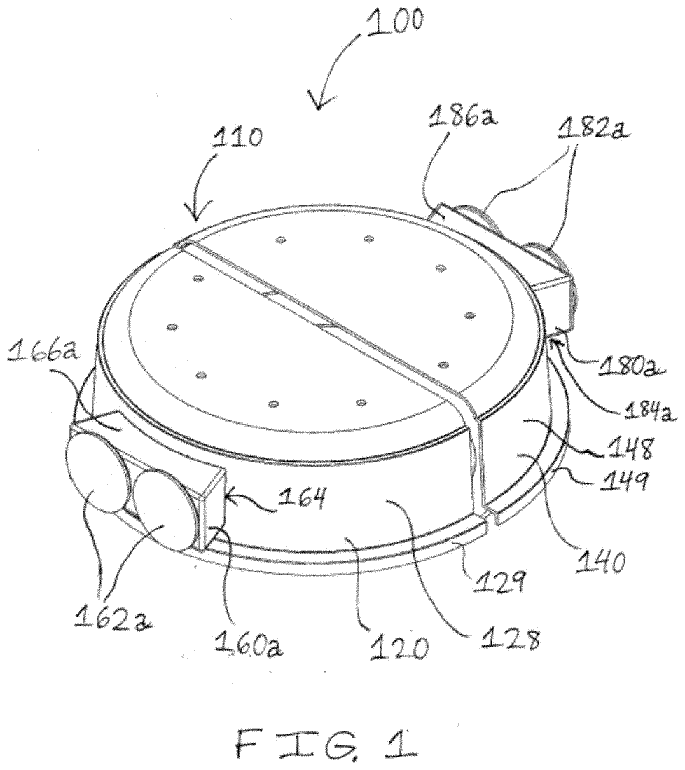

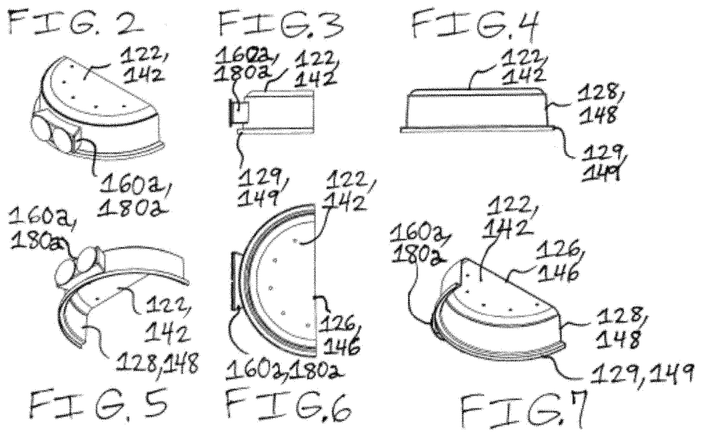

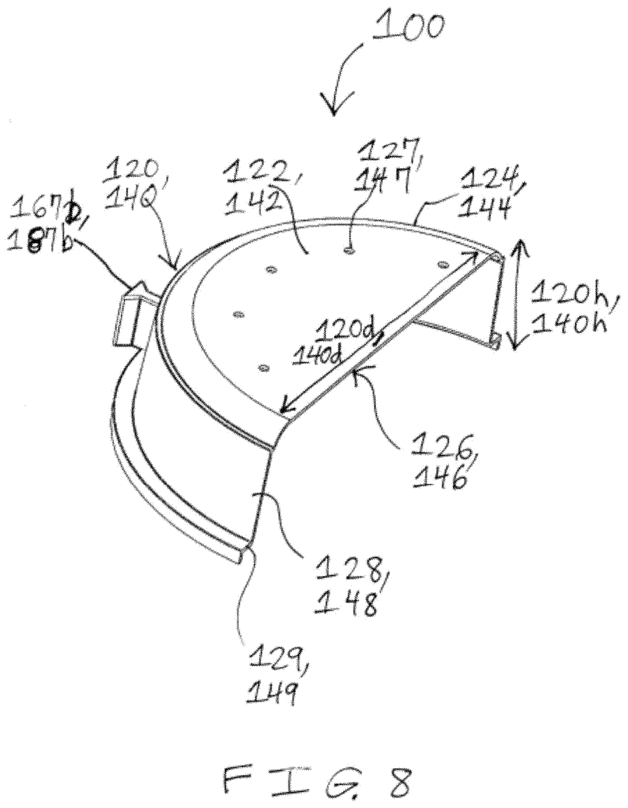

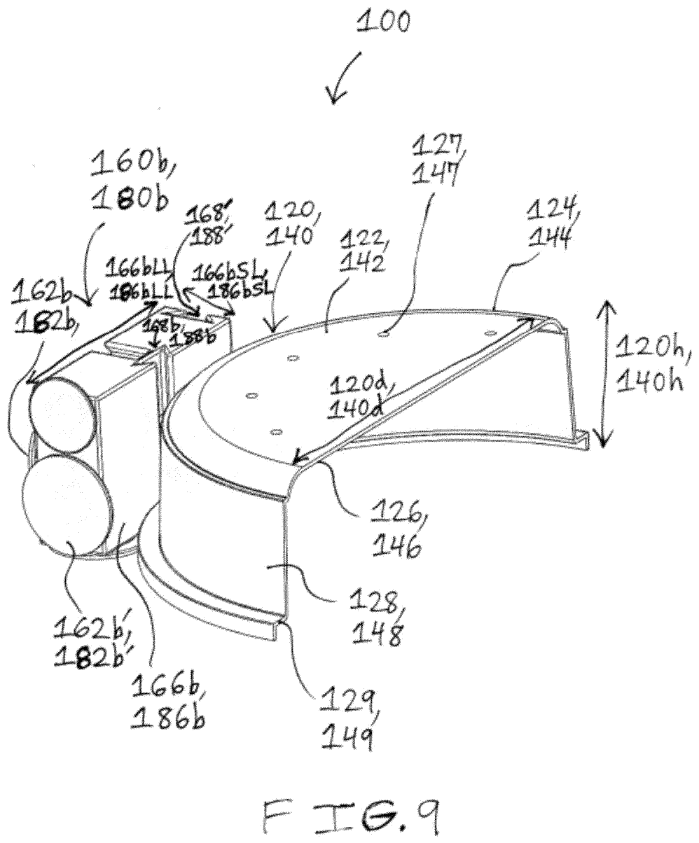

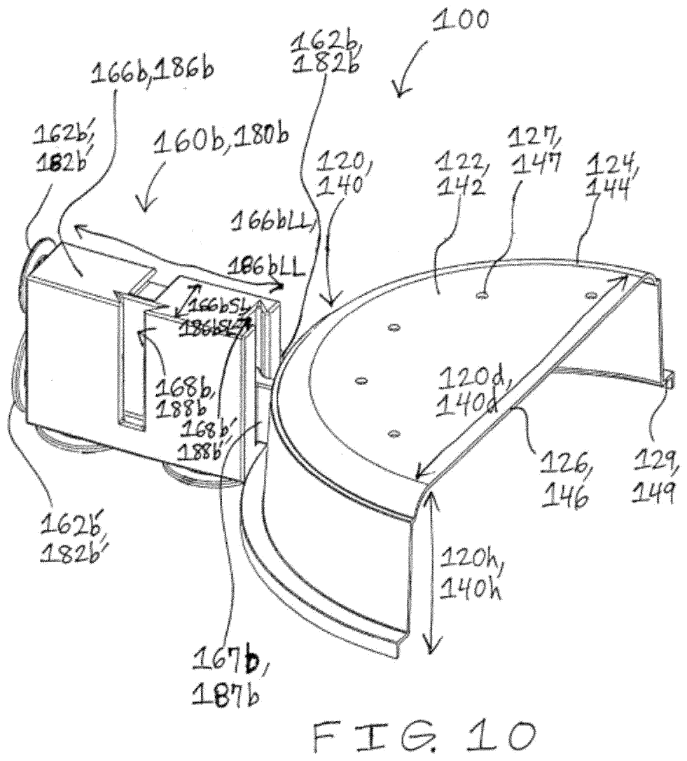

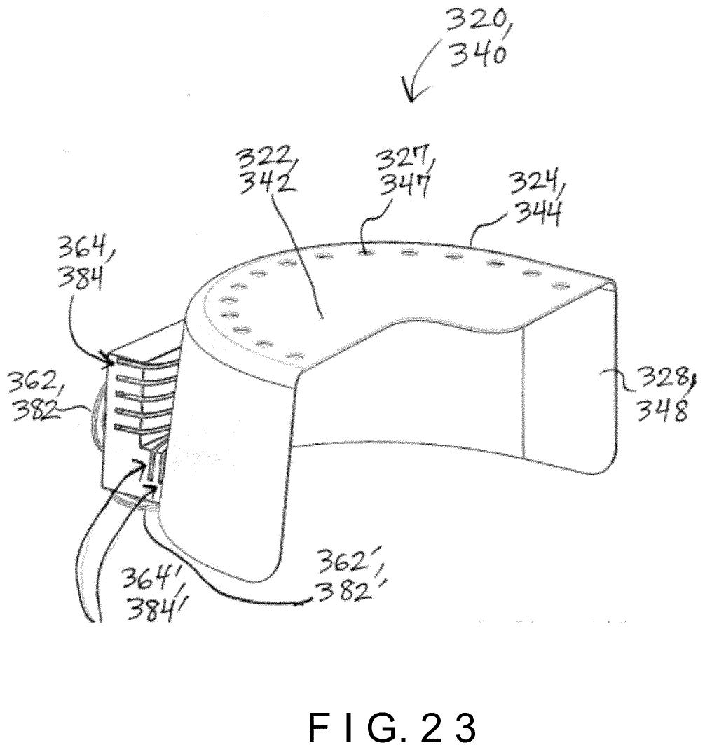

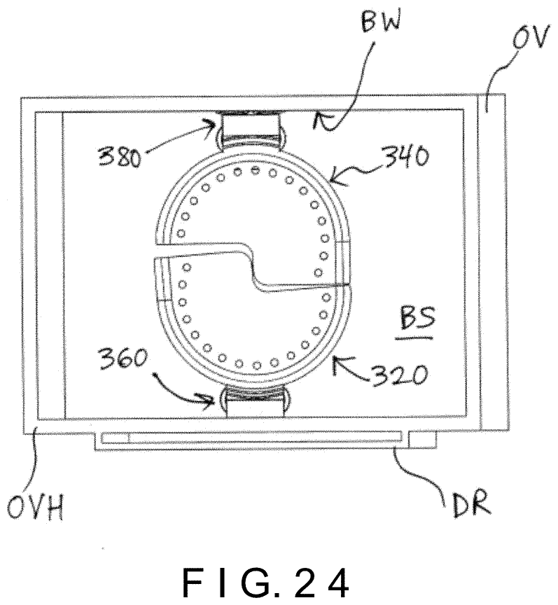

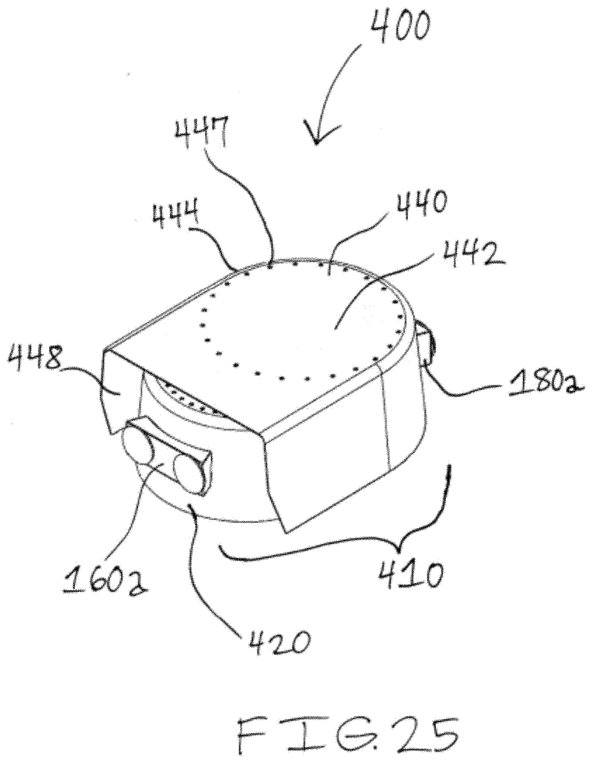

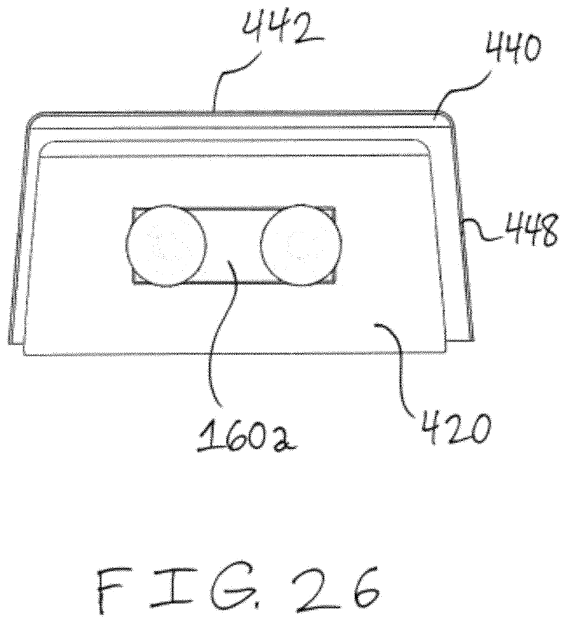

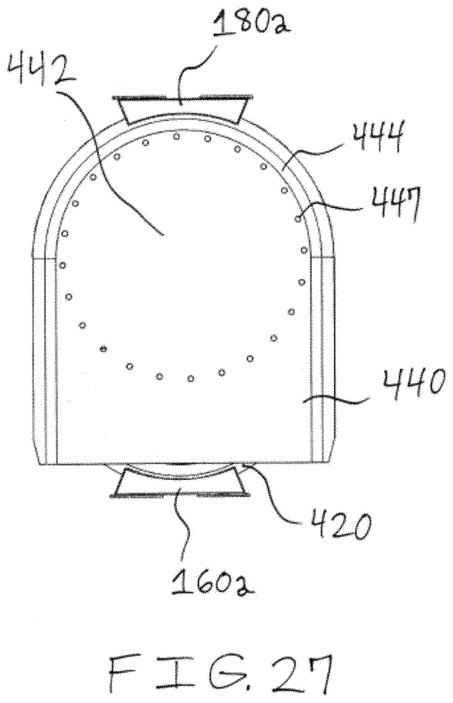

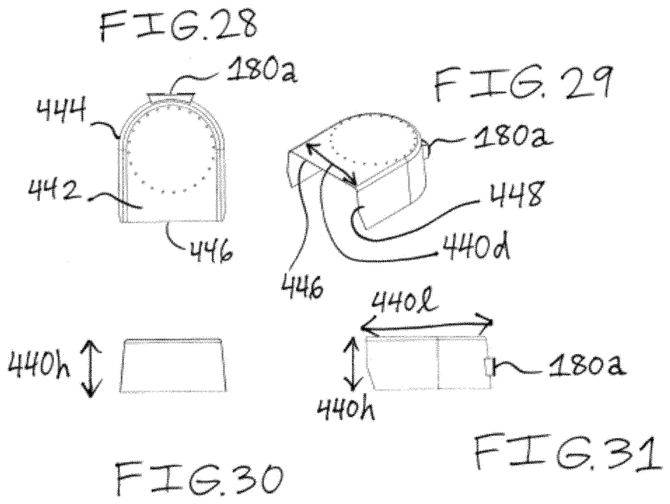

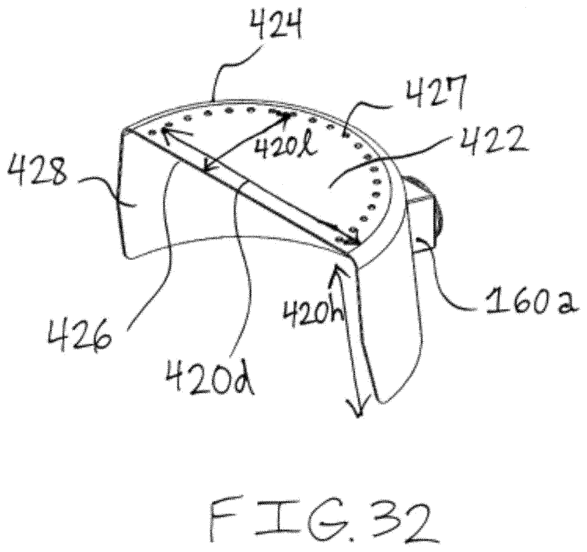

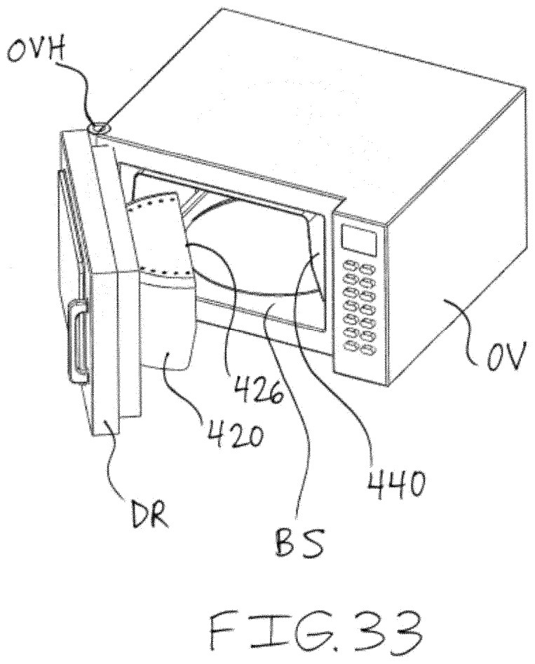

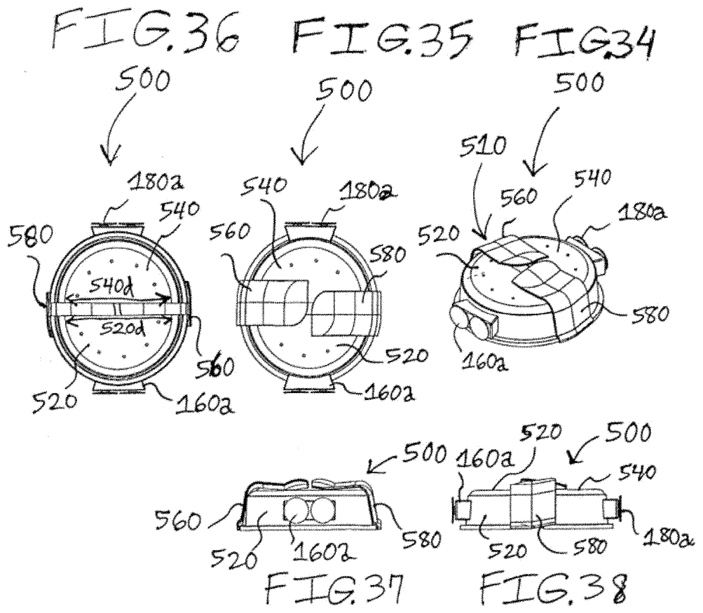

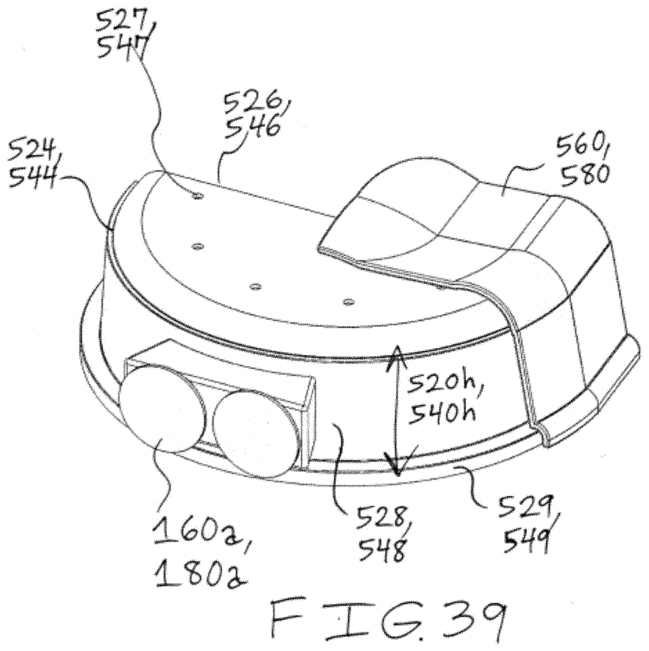

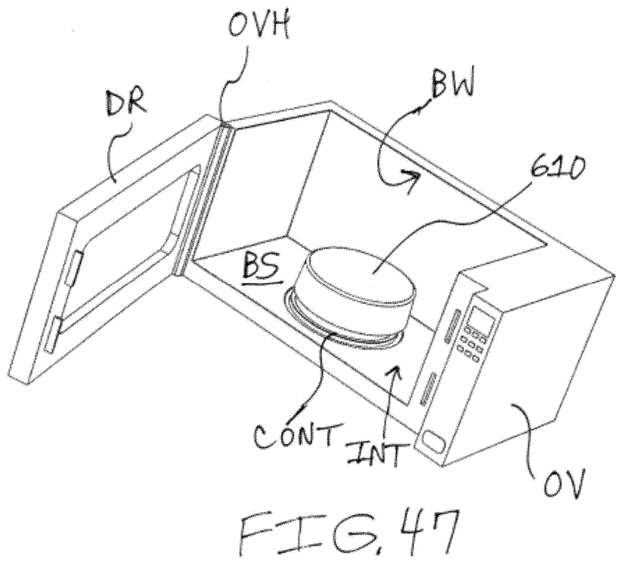

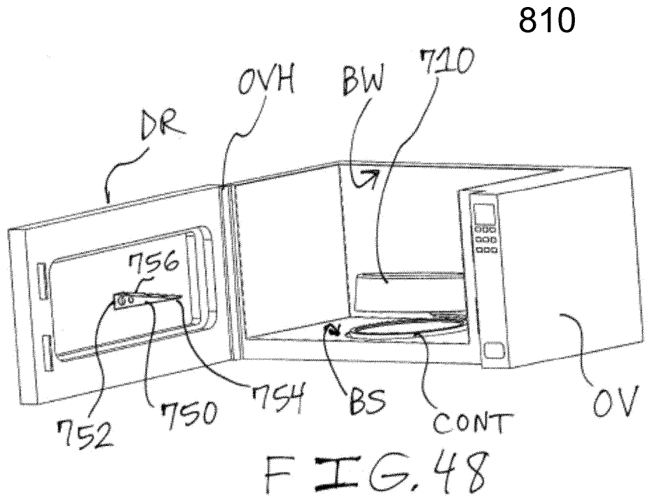

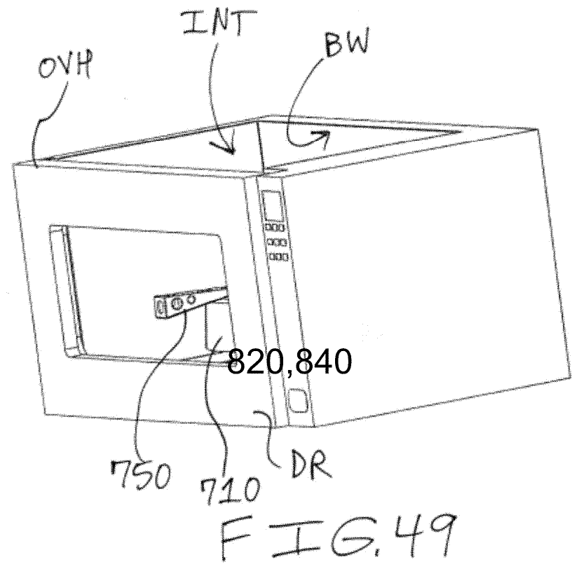

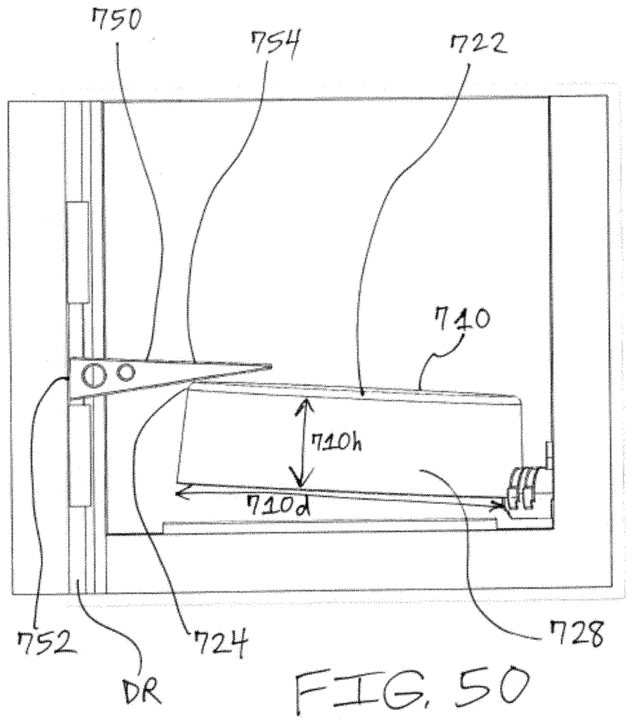

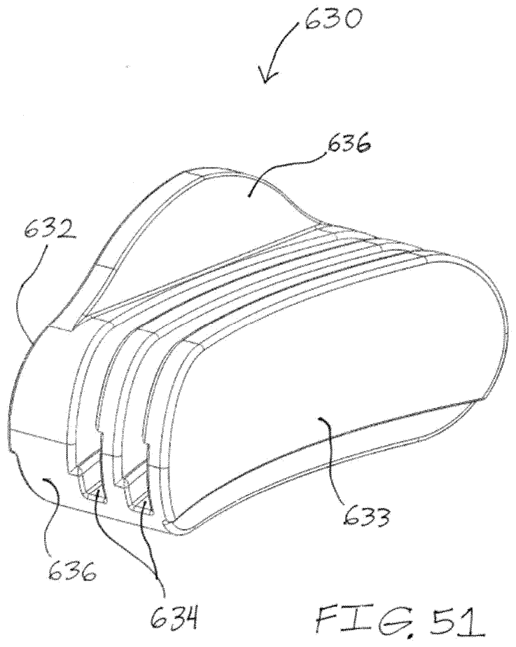

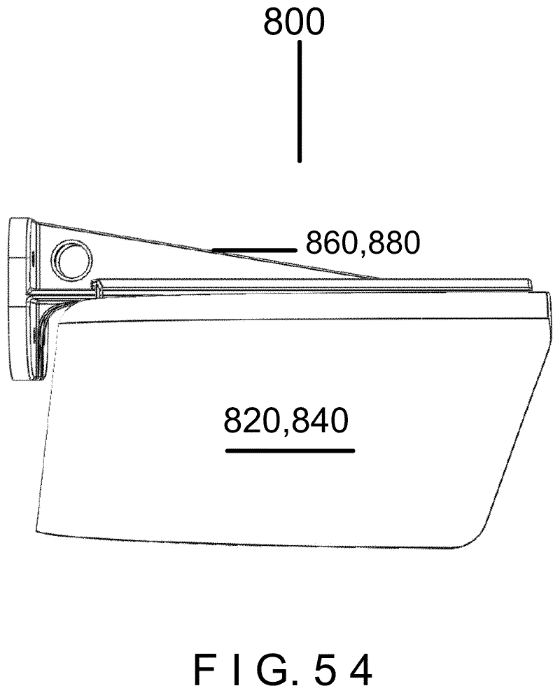

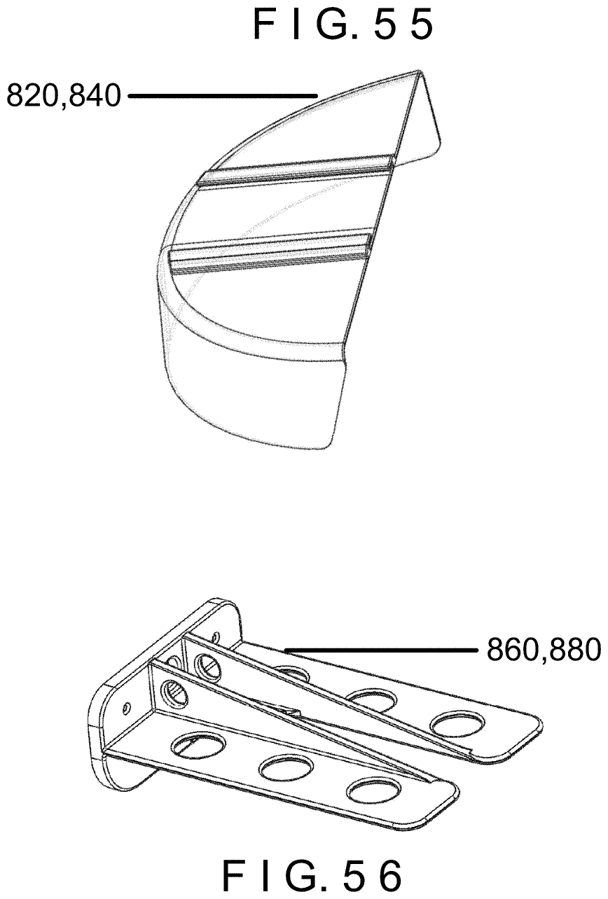

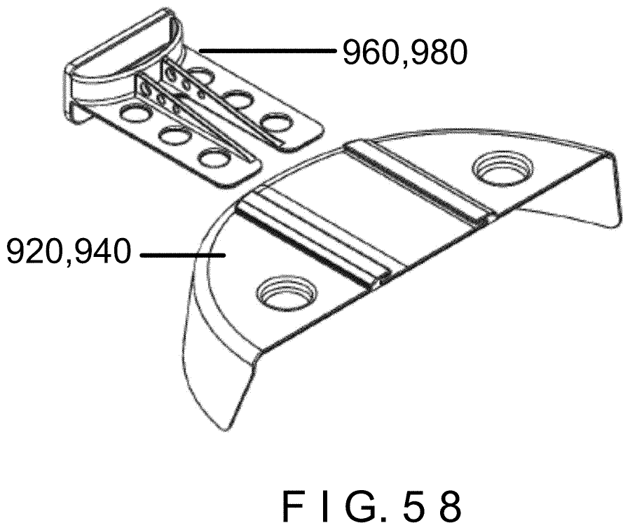

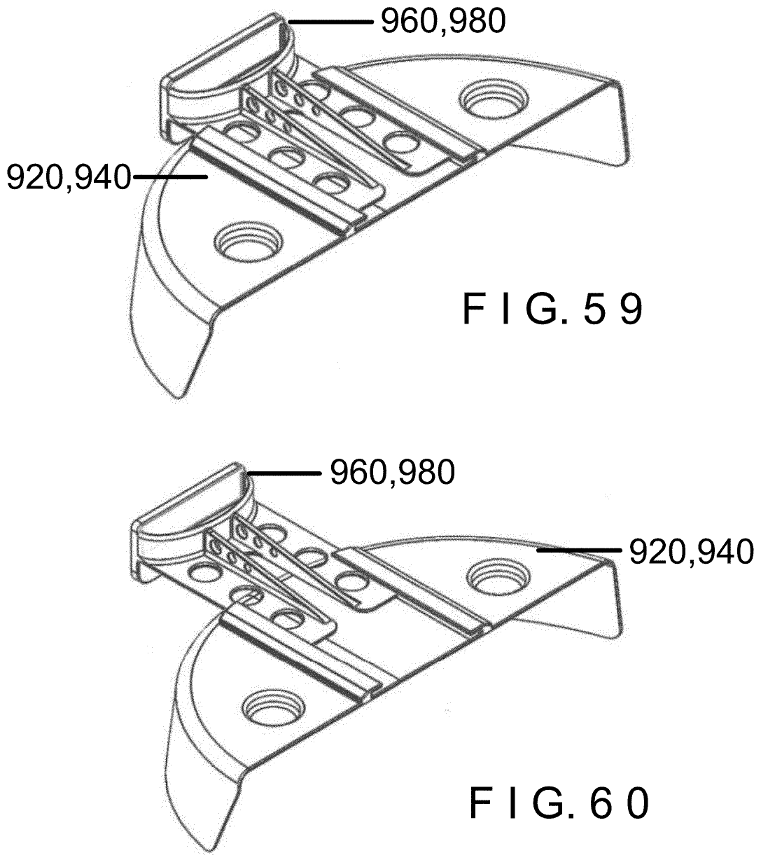

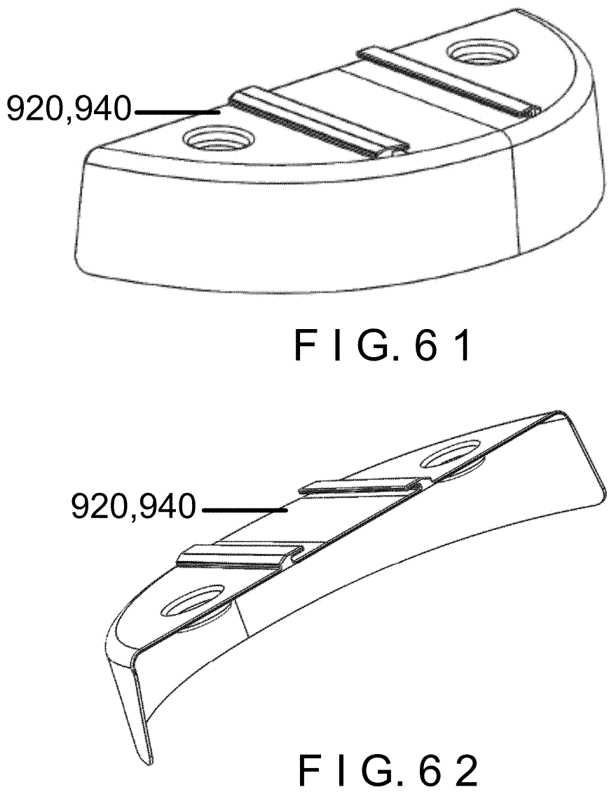

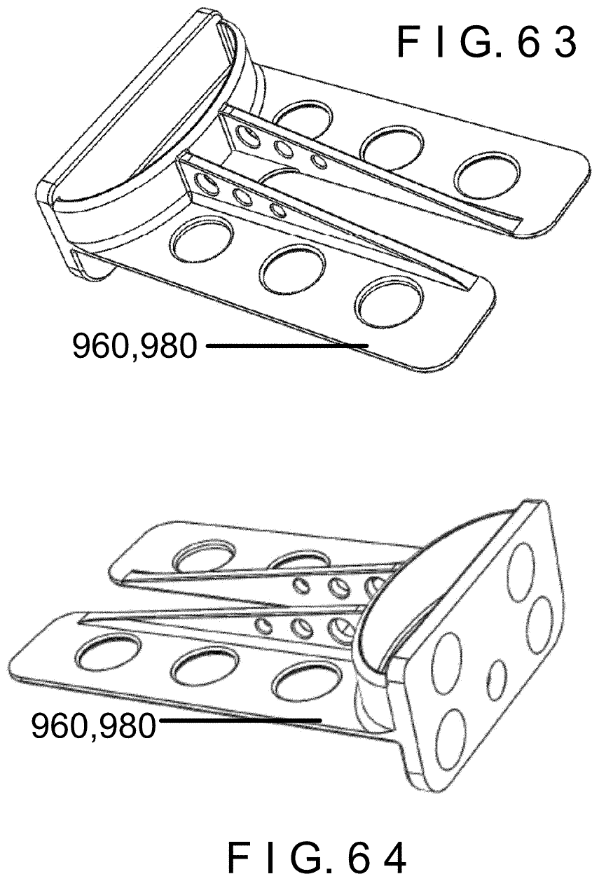

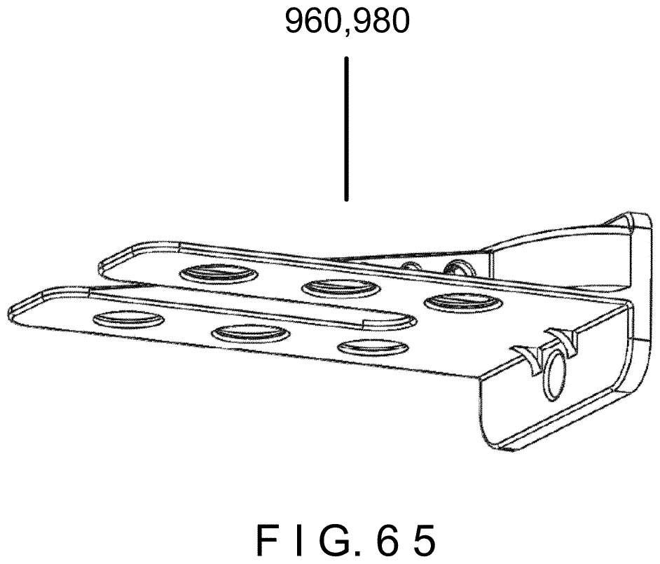

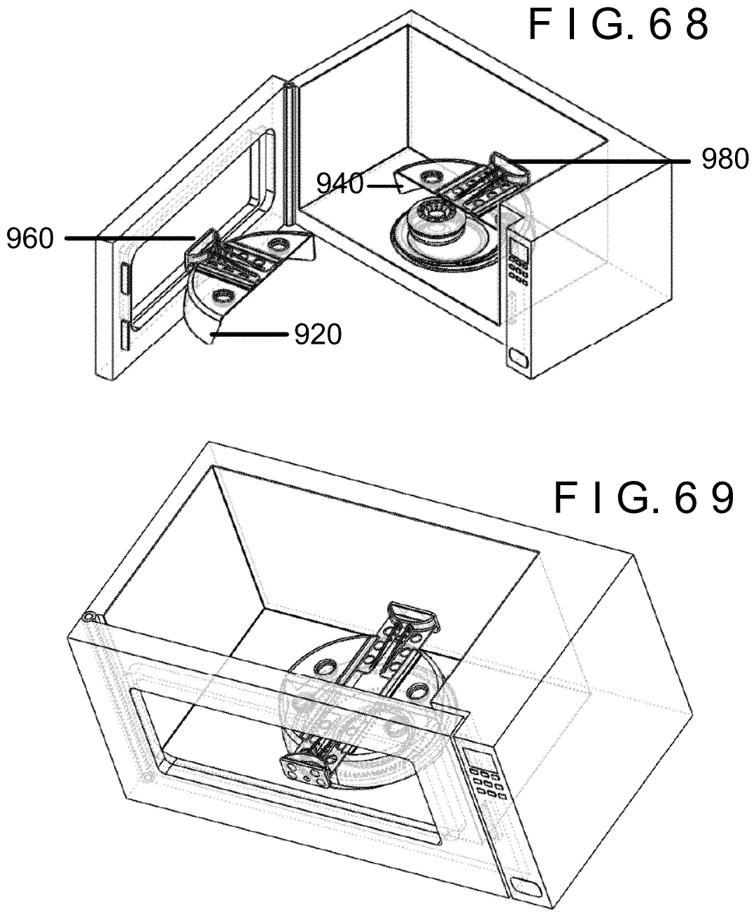

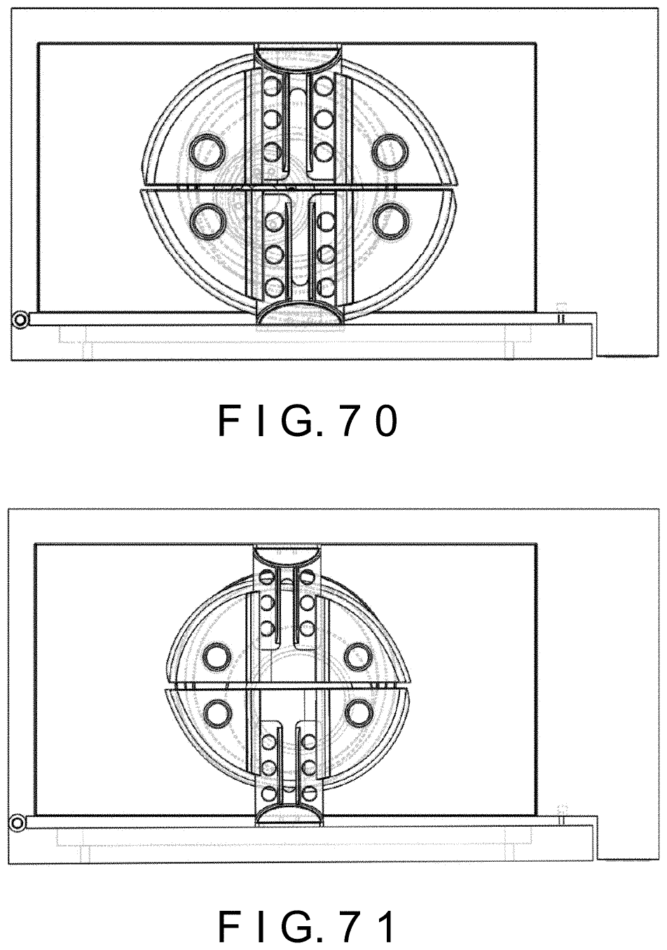

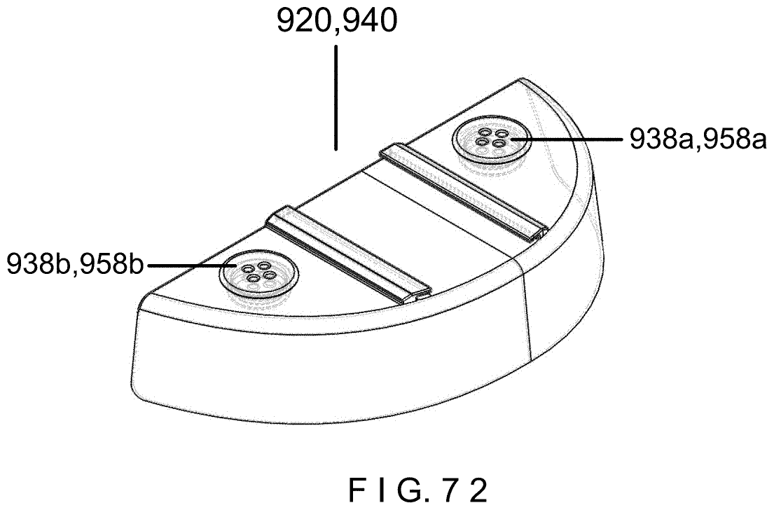

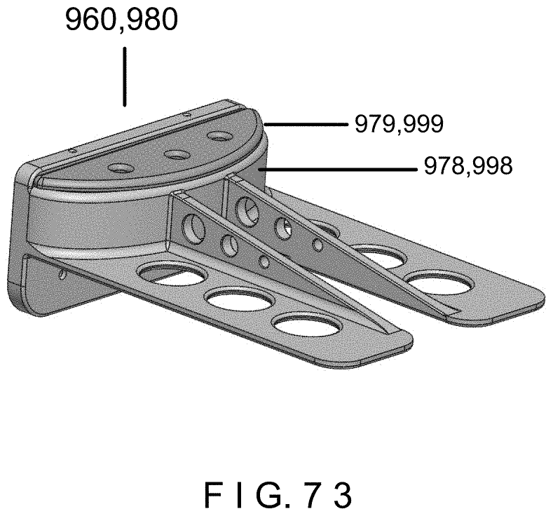

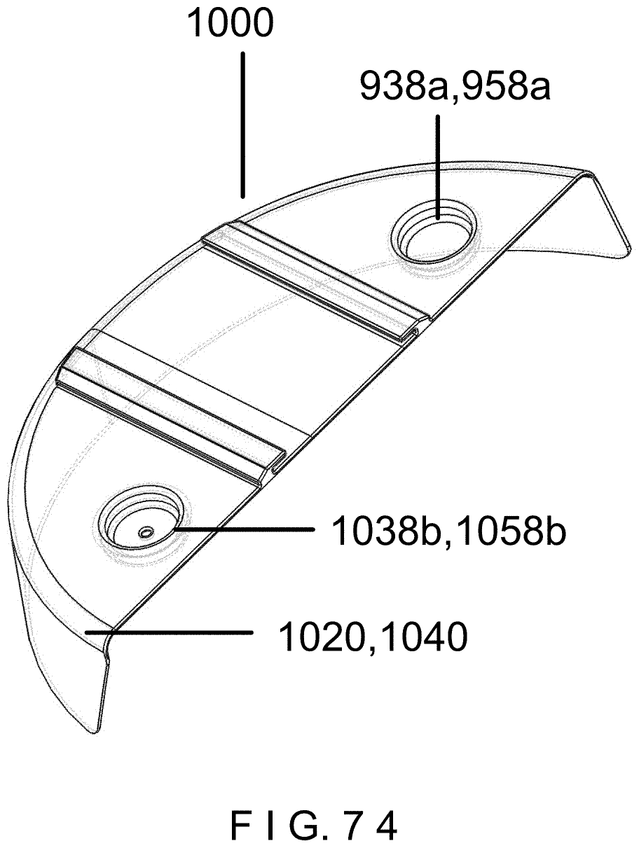

Referring to FIGS. 1-74, one aspect of the present invention is a splatter cover 110,210,310,410,510,810,910,1010 for minimizing or preventing food and drink splatters inside microwave ovens OV. The splatter cover can be a one-piece, splatter cover 610,710 (as shown in FIGS. 45-50), a two-piece, splatter cover 110,210,310,410,810,910,1010 (as shown in FIGS. 1-13, 21-33, and 53-74), or a splatter cover 510 made or manufactured of more than two pieces or sections (as shown in FIGS. 34-39). Another aspect of the present invention is a splatter cover apparatus 100,200,300,400,500,800,900,1000 that includes a splatter cover 110,210,310,410,510,810,910,1010 and at least one securing or mounting device 160a,160b,180a,180b,260,260′,260″,260′″,260″″, 280,280′,280″, 280′″,280″″,360,360′,360″,360′″,360″″,380,380′,380″,380′″,380″″,660,680,860, 880,960,980, such as, but not limited to, a first securing or mounting device 160a,160b,260,260′,260″, 260′″,260″,360,360′,360″,360′″,360″″,660,860, 960 and a second securing or mounting device 180a,180b,280,280′,280″,280′″, 280″″,380,380′,380″,380′″,380″″,680,880,980, for minimizing or preventing food and drink splatters inside microwave ovens OV. When the splatter cover is a two-piece, splatter cover 110,210,310,410,810,910,1010 or a splatter cover 510 made or manufactured of more than two pieces, then it's preferred that the splatter cover apparatus 100,200, 300,400,500,800,900,1000 includes both the first securing or mounting device 160a,160b,260, 260′,260″,260′″,260″″,360,360′, 360″,360′″,360″″,660,860,960 and second securing or mounting device 180a, 180b,280,280′,280″,280′″,280″″,380,380′,380″,380′″,380″″,680,880,980. In general, the splatter cover 110,210,310, 410,510,810,910,1010 and splatter cover apparatus 100, 200,300,400,500,800,900,1000 are preferably left in place inside the microwave oven OV after use and when the microwave oven OV is not in use.

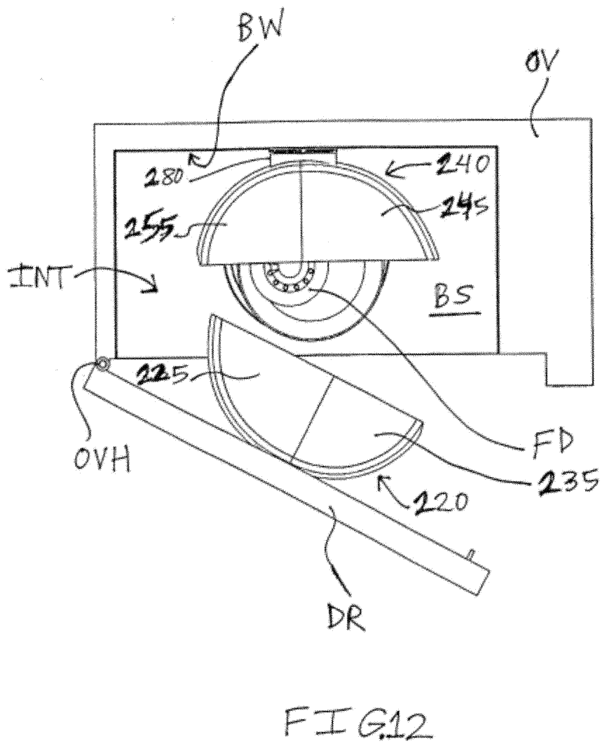

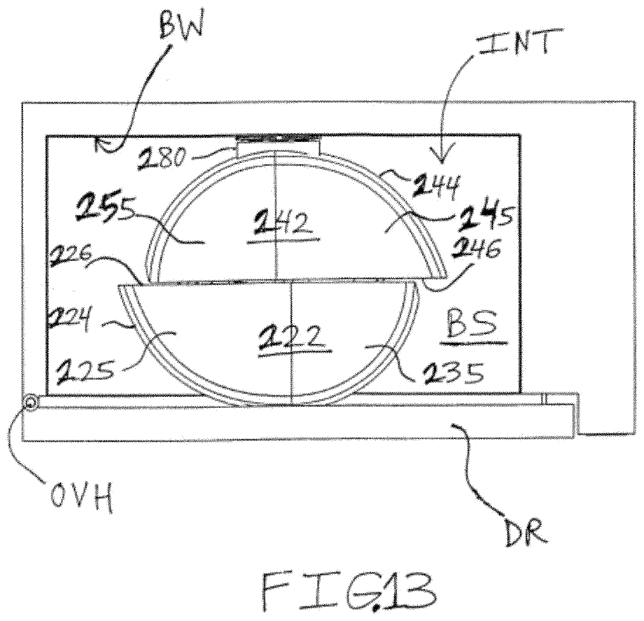

With regard to the different embodiments of the present invention where the splatter cover is a two-piece, splatter cover 110,210,310,410,810,910,1010, each of the first cover section 120,220,320,420,820,920,1020 and second cover section 140,240,340,440,840,940,1040 of a particular embodiment may have various dimensions and configurations to complement the dimensions and configurations of one another such that, preferably prior to operation but, alternatively, could be soon after operation initiation, the first cover section 120,220,320,420,820,920,1020 and second cover section 140,240,340,440,840, 940,1040 are initiated for operation by the user, such as, but not limited to, when the door DR of the microwave oven OV goes from the open position (shown in FIG. 12) to the closed position (shown in FIG. 13) by the user closing the door DR, to come together or toward one another to operationally form the two-piece, splatter cover 110,210,310,420,820,920,1020 and partially, substantially, or entirely surround and/or cover the food FD, drink, and/or food or beverage container, vessel, heating element, or retaining device CONT (shown in FIGS. 11-12), such as, but not limited to, a cup, a mug, a bowl, a plate, a food storage container, a food heating container, or a food defrosting container, to minimize or prevent splatters during microwave oven operation. When the first cover section 120,220,320,420, 820,920,1020 and second cover section 140,240,340,440,840, 940,1040 come together or toward one another to operationally form the two-piece, splatter cover 110,210,310,410,810,910,1010, the engagement surface or area 126,226,326, 426,826,926 of the first cover section 120,220,320,420,820, 920,1020 and the engagement surface or area 146,246,346,446,846,946 of the second cover section 140,240,340,840,940,1040 may meet and touch one another, may be separated by a small distance that creates a vent operationally while still minimizing or preventing splatters (as shown in FIGS. 1, 13 and 24), or may be positioned under and over the top of one another due to different sizes of the first cover section 420 and second cover section 440 (shown in FIGS. 25-27 and 33).

In a non-limiting, first embodiment (as shown in FIGS. 1-10) of the present invention, the splatter cover apparatus 100 is comprised of a two-piece, splatter cover 110 (which is nicknamed the “simple split cover”), a first securing or mounting device 160a,160b, and a second securing or mounting device 180a,180b.

The two-piece, splatter cover 110 is comprised of a first or door cover section 120 and a second or back wall cover section 140, and is dimensioned and configured as a one-piece unit, when the first cover section 120 and second cover section 140 come together or toward one another for use, to sufficiently and effectively cover foods and drinks during use (heating or defrosting) such that food and drink splatters are minimized or prevented inside a microwave oven OV. In this non-limiting, first embodiment, the first cover section 120 and second cover section 140 are preferably substantially similar to or exactly the same as one another.

The first or door cover section 120 preferably has both a first cover section height 120h and a first cover section diameter 120d. As a non-limiting example, the first cover section 120 preferably includes a top 122 having a perimeter 124, an engagement surface or area 126, and a plurality of vent holes or apertures 127, and also includes a sidewall 128 extending downward from the perimeter 124 of the top 122 and a flange 129 extending outward from the bottom of the sidewall 128. The top 122 has a semi-circle or half-circle configuration.

The first cover section 120 is capable of being detachably attached, secured or mounted in proximity or the vicinity of a first side or wall, such as the door DR (or a side or wall adjacent to the door DR), of the interior INT of the microwave oven OV by the first securing or mounting device 160a at a securing or mounting height with respect to a bottom side BS of the interior INT of the microwave oven OV.

The second or back wall cover section 140 preferably has both a second cover section height 140h and a second cover section diameter 140d. As a non-limiting example, the second cover section 140 includes a top 142 having a perimeter 144, an engagement surface or area 146, and a plurality of vent holes or apertures 147, and also includes a sidewall 148 extending downward from the perimeter 144 of the top 142 and a flange 149 extending outward from the bottom of the sidewall 148. The top 142 has a semi-circle or half-circle configuration such that the top 122 and top 142 form a circle configuration when they come together or toward one another to operationally form the two-piece, splatter cover 110.

The second cover section 140 is capable of being detachably attached, secured or mounted in proximity or the vicinity of a second side or wall, such as the back wall BW (or a side or wall adjacent to the back wall BW and also opposite to the side or wall that is adjacent to the door DR), of the interior INT of the microwave oven OV by the second securing or mounting device 180a at a securing or mounting height with respect to the bottom side BS of the interior INT of the microwave oven OV.

As a non-limiting example of securing or mounting devices and as shown in FIGS. 1-7, each of the first securing or mounting device 160a and second securing or mounting device 180a is a suction-type securing or mounting device. Preferably, the first securing or mounting device 160a and second securing or mounting device 180a are preferably substantially similar to or exactly the same as one another.

The first securing or mounting device 160a comprises a first or door securing portion 162a, a second or first cover section securing portion 164a, and a body 166a disposed between or among the securing portions 162a and 164a. The first securing portion 162a is at least one suction 162a (preferably a pair of suctions 162a), and the second securing portion 164a is a securing surface 164a (preferably a curved, securing surface 164a) that is attached, secured or mounted to a corresponding portion of the first cover section 120 by any method, device or feature known to one of ordinary skill in the art, such as, but not limited to, adhesive. The pair of suctions 162a permit the first securing or mounting device 160a to be adjustable vertically (upward or downward relative to a first securing or mounting position) and also laterally (rightward or leftward relative to the first securing or mounting position) along the door DR (or a side or wall adjacent to the door).

The second securing or mounting device 180a comprises a first or back wall securing portion 182a, a second or second cover section securing portion 184a, and a body 186a disposed between or among the securing portions 182a and 184a. The first securing portion 182a is at least one suction 182a (preferably a pair of suctions 182a), and the second securing portion 184a is a securing surface 184a (preferably a curved, securing surface 184a) that is attached, secured or mounted to a corresponding portion of the second cover section 140 by any method, device or feature known to one of ordinary skill in the art, such as, but not limited to, adhesive. The pair of suctions 182a permit the second securing or mounting device 180a to be adjustable vertically (upward or downward relative to a first securing or mounting position) and also laterally (rightward or leftward relative to the first securing or mounting position) along the back wall BW (or a side or wall adjacent to the back wall BW and also opposite to the side or wall that is adjacent to the door DR).

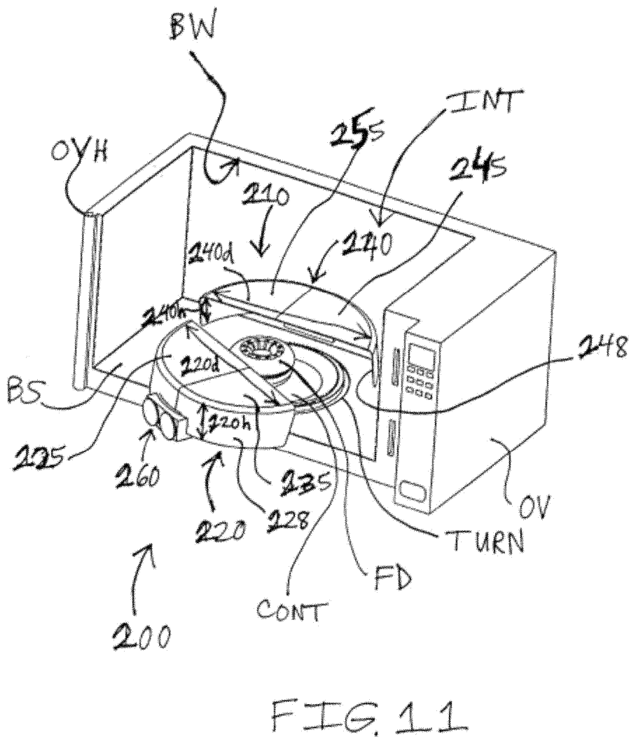

As another non-limiting example of securing or mounting devices and as shown in FIGS. 8-10 and 20, each of the first securing or mounting device 160b and second securing or mounting device 180b is a suction-type securing or mounting device. Preferably, the first securing or mounting device 160b and second securing or mounting device 180b are preferably substantially similar to or exactly the same as one another.

The first securing or mounting device 160b comprises a first or door securing portion 162b, a second or first cover section securing portion 164b, and a body 166b disposed between or among the securing portions 162b and 164b. The first securing portion 162b is two sets of at least one suction 162b,162b′ (preferably two pairs of suctions 162b,162b′), and the second securing portion 164b is two combinations of a tail 167b and vertical slot 168b,168b′. Each of the pair of suctions 162b,162b′ permit the first securing or mounting device 160b to be adjustable vertically (upward or downward relative to a first securing or mounting position) and also laterally (rightward or leftward relative to the first securing or mounting position) along the door DR (or a side or wall adjacent to the door DR). The first pair of suctions 162b is positioned at one end of a shorter length 166bSL (depending on the orientation of the first securing or mounting device 160b relative to the door DR) of the body 166b (as shown in FIG. 9) such that the door DR and first cover section 120 will be closer to one another to accommodate, for example, a larger food container CONT. The second pairs of suctions 162b′ is positioned at one end of a longer length 166bLL (depending on the orientation of the first securing or mounting device 160b relative to the door DR) of the body 166b (as shown in FIG. 10) such that the door DR and first cover section 120 will be further away from one another to accommodate, for example, a smaller food container CONT. The tail 167b is attached, secured or mounted to a corresponding portion of the first cover section 120 by any method, device or feature known to one of ordinary skill in the art, such as, but not limited to, adhesive or being manufactured with the first cover section 120. The vertical slot 168b is dimensioned and configured to receive and detachably retain the tail 167b, and is positioned at the other end of the shorter length 166bSL of the body 166b (as shown in FIG. 9). The vertical slot 168b′ is dimensioned and configured to receive and detachably retain the tail 167b, and is positioned at the other end of the longer length 166bLL of the body 166b (as shown in FIG. 10).

The second securing or mounting device 180b comprises a first or back wall securing portion 182b, a second or second cover section securing portion 184b, and a body 186b disposed between or among the securing portions 182b and 184b. The first securing portion 182b is two sets of at least one suction 182b,182b′ (preferably two pairs of suctions 182b,182b′), and the second securing portion 184b is two combinations of a tail 187b and vertical slot 188b,188b′. Each of the pair of suctions 182b,182b′ permit the second securing or mounting device 180b to be adjustable vertically (upward or downward relative to a first securing or mounting position) and also laterally (rightward or leftward relative to the first securing or mounting position) along the back wall BW (or a side or wall adjacent to the back wall BW). The first pair of suctions 182b is positioned at one end of a shorter length 186bSL (depending on the orientation of the first securing or mounting device 180b relative to the back wall BW) of the body 186b (as shown in FIG. 9) such that the back wall BW and second cover section 140 will be closer to one another to accommodate, for example, a larger food container CONT. The second pairs of suctions 182b′ is positioned at one end of a longer length 186bLL (depending on the orientation of the second securing or mounting device 180b relative to the back wall BW) of the body 186b (as shown in FIG. 10) such that the back wall BW and second cover section 140 will be further away from one another to accommodate, for example, a smaller food container CONT. The tail 187b is attached, secured or mounted to a corresponding portion of the second cover section 140 by any method, device or feature known to one of ordinary skill in the art, such as, but not limited to, adhesive or being manufactured with the second cover section 140. The vertical slot 188b is dimensioned and configured to receive and detachably retain the tail 187b, and is positioned at the other end of the shorter length 186bSL of the body 186b (as shown in FIG. 9). The vertical slot 188b′ is dimensioned and configured to receive and detachably retain the tail 187b, and is positioned at the other end of the longer length 186bLL of the body 186b (as shown in FIG. 10).

In a non-limiting, second embodiment (as shown in FIGS. 11-13) of the present invention, the splatter cover apparatus 200 is comprised of a two-piece, splatter cover 210 (which is nicknamed the “Nautilus cover”), a first securing or mounting device 260, and a second securing or mounting device 280.

The two-piece, splatter cover 210 is comprised of a first or door cover section 220 and a second or back wall cover section 240, and is dimensioned and configured as a one-piece unit, when the first cover section 220 and second cover section 240 come together or toward one another for use, to sufficiently and effectively cover foods and drinks during use (heating or defrosting) such that food and drink splatters are minimized or prevented inside a microwave oven OV. In this non-limiting, second embodiment, the first cover section 220 and second cover section 240 are preferably substantially similar to or exactly the same as one another.

Further, in this non-limiting, second embodiment, the two-piece, splatter cover 210 may comprise at least one, preferably, both, of the two cover sections 220,240 comprising a larger portion 225,245 and a smaller portion 235,255, respectively, in order to allow clearance of the splatter cover 210 past the microwave oven opening or entry when the door DR is closed and, alternatively, opened. Preferably, as best shown in FIGS. 11 and 13, the smaller portion 235 of the first or door cover section 220 is positioned about the microwave oven opening or entry while the larger portion 225 of the first or door cover section 220 is positioned about the microwave oven hinge OVH. Alternatively, the smaller portion 235 of the first or door cover section 220 may be radiused or angled in order to allow clearance of the first or door cover section 220 past the microwave oven opening or entry. This design allows the two sections 220,240 to fit into a large microwave oven and also a small microwave oven.

The first cover section 220 preferably has both a first cover section height 220h and a first cover section diameter 220d. As a non-limiting example, the first cover section 220 preferably includes a top 222 having a perimeter 224 and an engagement surface or area 226, and also includes a sidewall 228 extending downward from the perimeter 224 of the top 222. The top 222 has a general semi-circle or general half-circle configuration.

The first cover section 220 is capable of being detachably attached, secured or mounted in proximity or the vicinity of a first side or wall, such as the door DR (or a side or wall adjacent to the door DR), of the interior INT of the microwave oven OV by the first securing or mounting device 260 at a securing or mounting height with respect to a bottom side BS of the interior INT of the microwave oven OV.

The second or back wall cover section 240 preferably has both a second cover section height 240h and a second cover section diameter 240d. As a non-limiting example, the second cover section 240 includes a top 242 having a perimeter 244 and an engagement surface or area 246, and also includes a sidewall 248 extending downward from the perimeter 244 of the top 242. The top 242 has a general semi-circle or general half-circle configuration such that the top 222 and top 242 form a general circle configuration when they come together or toward one another to operationally form the two-piece, splatter cover 210.

The second cover section 240 is capable of being detachably attached, secured or mounted in proximity or the vicinity of a second side or wall, such as the back wall BW (or a side or wall adjacent to the back wall BW and also opposite to the side or wall that is adjacent to the door DR), of the interior INT of the microwave oven OV by the second securing or mounting device 280 at a securing or mounting height with respect to the bottom side BS of the interior INT of the microwave oven OV.

As shown in FIG. 13, when the first cover section 220 and second cover section 240 come together or toward one another to operationally form the two-piece, splatter cover 210, the engagement surface or area 226 of the first cover section 220 and the engagement surface or area 246 of the second cover section 240 may be separated by a small distance and/or also may be offset with one another that creates a vent operationally while still minimizing or preventing splatters.

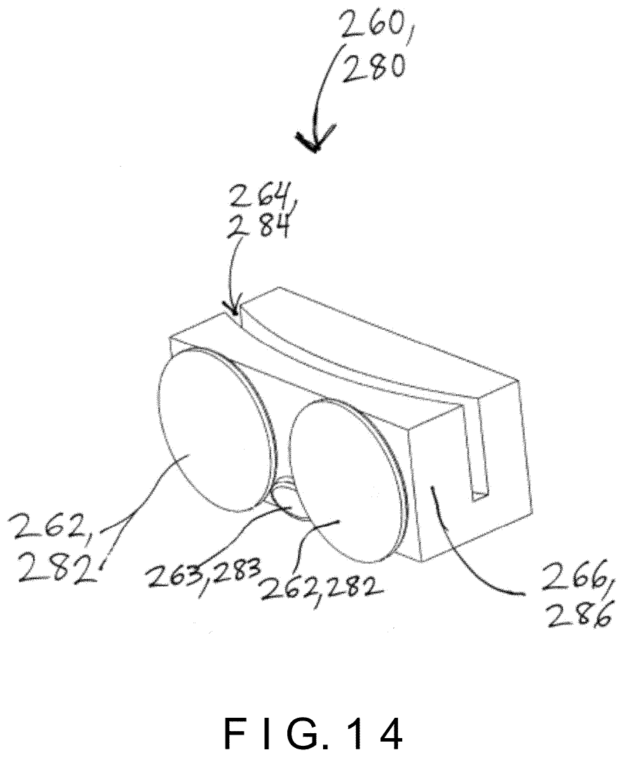

As a non-limiting example of securing or mounting devices and as best shown in FIG. 14, each of the first securing or mounting device 260 and second securing or mounting device 280 is a suction-type securing or mounting device having at least one securing slot. Preferably, the first securing or mounting device 260 and second securing or mounting device 280 are preferably substantially similar to or exactly the same as one another.

The first securing or mounting device 260 comprises a first or door securing portion 262, a second or first cover section securing portion 264, and a body 266 disposed between or among the securing portions 262 and 264. The first securing portion 262 includes at least one suction 262 (preferably a pair of suctions 262) and, preferably, at least one magnet 263, and the second securing portion 264 is at least one securing slot 264 that is dimensioned and configured for receiving and securing a corresponding portion of the first cover section 220. The pair of suctions 262 and, preferably, at least one magnet 263 permit the first securing or mounting device 260 to be adjustable vertically (upward or downward relative to a first securing or mounting position) and also laterally (rightward or leftward relative to the first securing or mounting position) along the door DR (or a side or wall adjacent to the door).

The second securing or mounting device 280 comprises a first or back wall securing portion 282, a second or second cover section securing portion 284, and a body 286 disposed between or among the securing portions 282 and 284. The first securing portion 282 is at least one suction 282 (preferably a pair of suctions 282) and, preferably, at least one magnet 283, and the second securing portion 284 is at least one securing slot 284 that is dimensioned and configured for receiving and securing a corresponding portion of the second cover section 240. The pair of suctions 282 and, preferably, at least one magnet 283 permit the second securing or mounting device 280 to be adjustable vertically (upward or downward relative to a first securing or mounting position) and also laterally (rightward or leftward relative to the first securing or mounting position) along the back wall BW (or a side or wall adjacent to the back wall BW and also opposite to the side or wall that is adjacent to the door DR).

As other non-limiting examples of securing or mounting devices and as shown in FIGS. 1-20, each of the first securing device 160,260,260′,260″,260′″, 260″″,360,460,560 and second securing or mounting device 280,280′,280″,280′″, 280″″,380,480,580 may be any securing or mounting device according to the present invention, any similar securing or mounting device known to one of ordinary skill in the art, and any combination thereof. Each pair of the first securing or mounting device 160,260,260′,260″,260′″,260″″,360,460,560 and second securing or mounting device 280,280′,280″,280′″,280″″,380,480,580 preferably may be a pair of substantially similar or exactly the same securing or mounting device or a mix and match combination of securing or mounting devices.

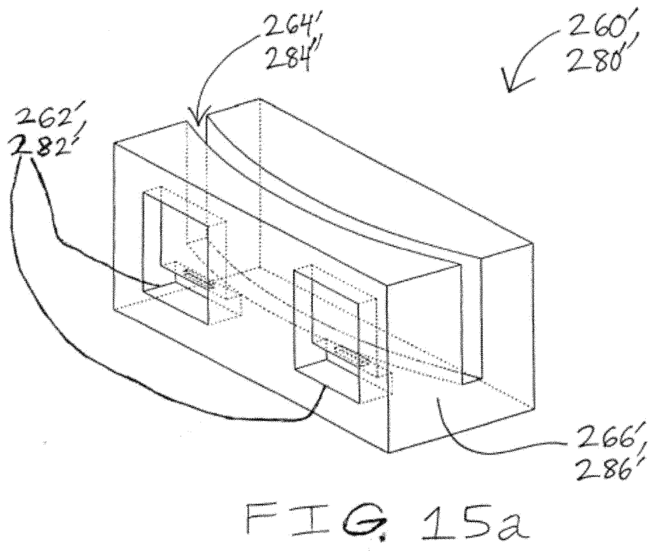

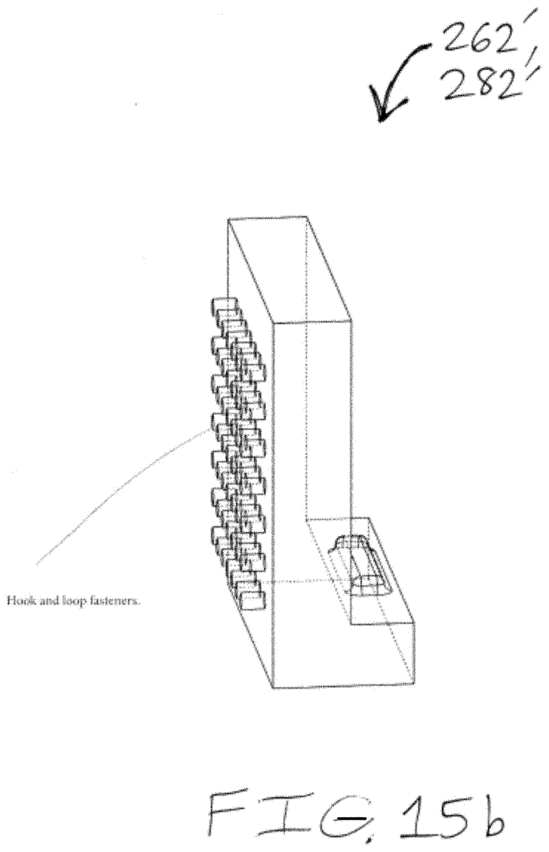

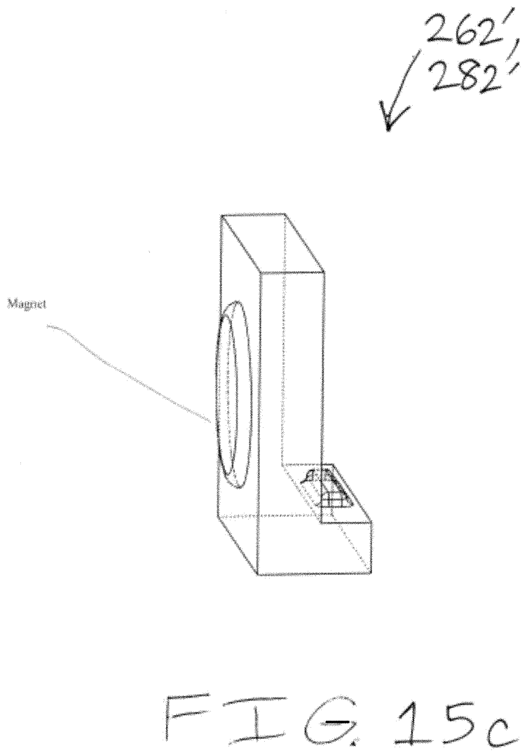

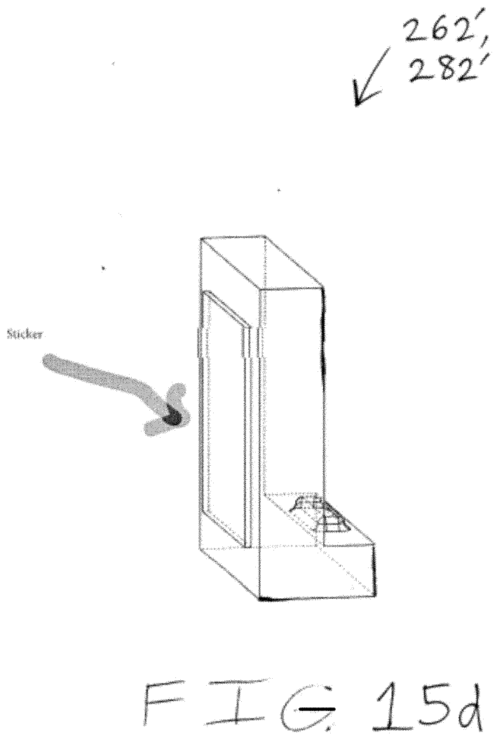

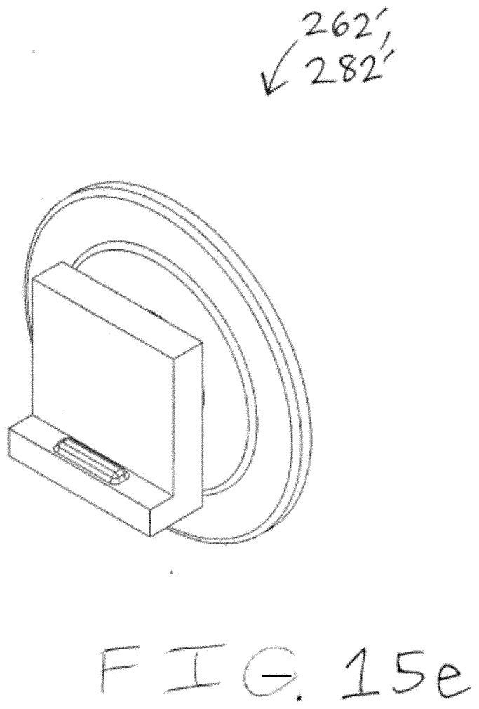

FIG. 15a shows a cover holder device 260′,280′ (similar to 260,280) using detachable “L-shaped” mounting clips as a non-limiting example of both the first securing or mounting device 260′ and second securing or mounting device 280′. FIGS. 15b-15e show non-limiting examples of detachable “L-shaped” mounting clips. The first securing or mounting device 260′ comprises a first or door securing portion 262′, a second or first cover section securing portion 264′ (preferably substantially similar to or exactly the same as 264), and a body 266′ disposed between or among the securing portions 262′ and 264′. The second securing or mounting device 280′ comprises a first or back wall securing portion 282′, a second or second cover section securing portion 284′ (preferably substantially similar to or exactly the same as 284), and a body 286′ disposed between or among the securing portions 282′ and 284′. Each of the securing portion 262′ and securing portion 282′ is at least one (preferably two) detachable “L-shaped” mounting clip, such as, but not limited to, a mounting clip comprising hook and look fasteners (to engage with hook and look fasteners positioned on the applicable microwave oven door DR or wall; shown in FIG. 15b), a mounting clip comprising at least one magnet (to engage with the applicable microwave oven door DR or wall; shown in FIG. 15c), a mounting clip comprising at least one sticker (to engage with the applicable microwave oven door DR or wall; shown in FIG. 15d), and a mounting clip comprising at least one suction cup (to engage with the applicable microwave oven door DR or wall; shown in FIG. 15e).

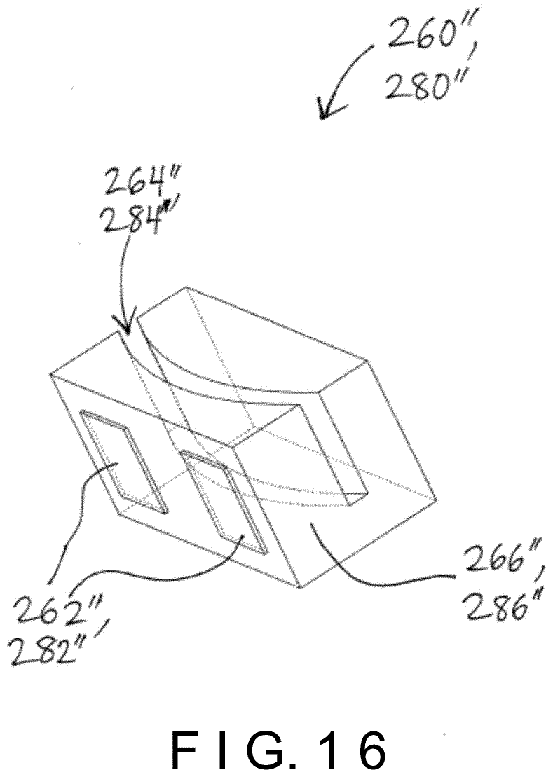

FIG. 16 shows a cover holder device 260″,280″ (similar to 260,260′, 280,280′) using at least one sticker as a non-limiting example of both the first securing or mounting device 260″ and second securing or mounting device 280″. The first securing or mounting device 260″ comprises a first or door securing portion 262″, a second or first cover section securing portion 264″ (preferably substantially similar to or exactly the same as 264,264′), and a body 266″ disposed between or among the securing portions 262″ and 264″. The second securing or mounting device 280″ comprises a first or back wall securing portion 282″, a second or second cover section securing portion 284″ (preferably substantially similar to or exactly the same as 284,284′), and a body 286″ disposed between or among the securing portions 282″ and 284″. Each of the securing portion 262″ and securing portion 282″ is at least one (preferably two) sticker.

FIG. 17 shows a cover holder device 260″,280″ (similar to 260,260′, 260″,280,280′,280″) using at least one magnet as a non-limiting example of both the first securing or mounting device 260′″ and second securing or mounting device 280′″. The first securing or mounting device 260′″ comprises a first or door securing portion 262″, a second or first cover section securing portion 264″ (preferably substantially similar to or exactly the same as 264,264′,264″), and a body 266″ disposed between or among the securing portions 262″ and 264″. The second securing device 280′″ comprises a first or back wall securing portion 282″, a second or second cover section securing portion 284″ (preferably substantially similar to or exactly the same as 284,284′,284″), and a body 286″ disposed between or among the securing portions 282″ and 284″. Each of the securing portion 262″ and securing portion 282″ is at least one (preferably two) magnet. Each cover holder device 260″,280″ may also include at least one bumper rest 265″,285″ that helps to keep the cover holder device 260″,280″ from drooping when the cover holder device 260′″,280′″ is mounted to the applicable microwave oven door DR or wall.

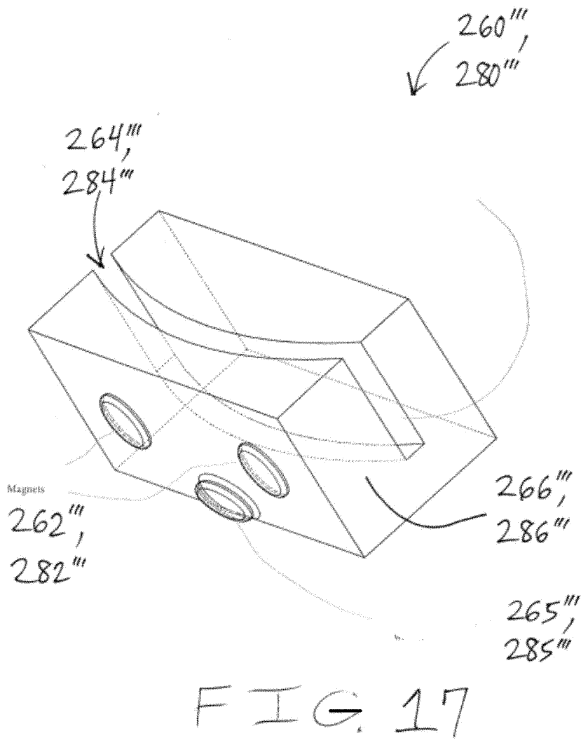

FIG. 18 shows a cover holder device 260″″,280″″ (similar to 260,260′, 260″,260′″,280,280′,280″,280′″) using at least one hook and loop fastener arrangement as a non-limiting example of both the first securing or mounting device 260″″ and second securing or mounting device 280″″. The first securing or mounting device 260″″ comprises a first or door securing portion 262″″, a second or first cover section securing portion 264″″ (preferably substantially similar to or exactly the same as 264,264′,264″,264′″), and a body 266″″ disposed between or among the securing portions 262″″ and 264″″. The second securing or mounting device 280″″ comprises a first or back wall securing portion 282″″, a second or second cover section securing portion 284″″ (preferably substantially similar to or exactly the same as 284,284′,284″,284′″), and a body 286″″ disposed between or among the securing portions 282″″ and 284″″. Each of the securing portion 262″″ and securing portion 282″″ is at least one (preferably two) arrangement of hook and loop fasteners.

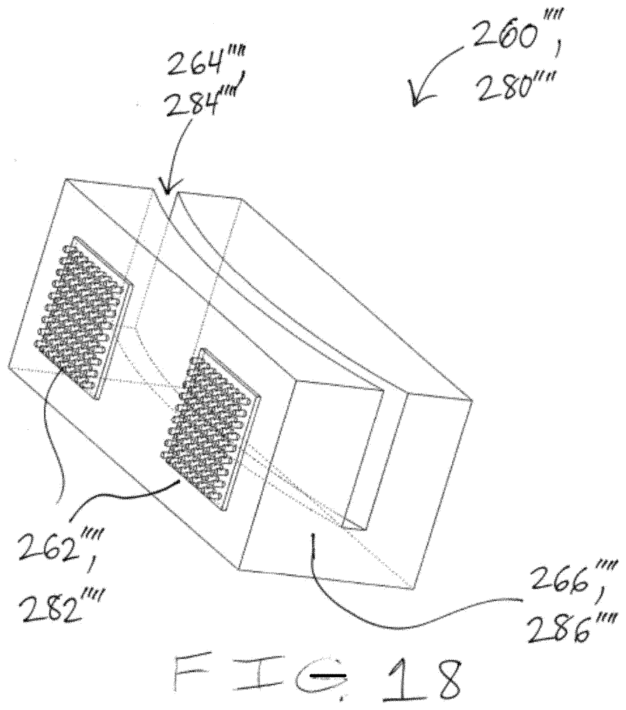

As another non-limiting example of securing or mounting devices and as best shown in FIG. 19, each of the first securing or mounting device 360 and second securing or mounting device 380 is an “L-shaped” securing or mounting device having a plurality of securing slots. Preferably, the first securing or mounting device 360 and second securing or mounting device 380 are substantially similar to or exactly the same as one another.

The first securing or mounting device 360 comprises an “L-shaped” configuration having a longer portion 361 and a shorter portion 361′. Each of the longer portion 361 and shorter portion 361′ has a first or door securing portion 362,362′, a second or first cover section securing portion 364,364′, and a body 366,366′ disposed between or among the securing portions 362,362′ and 364,364′, respectively. The first securing portion 362,362′ includes at least one suction cup 362,362′ (preferably a pair of suction cups 362,362′; not shown but would be located at the applicable locations), and the second securing portion 364,364′ is a plurality of securing slots 364,364′ that is dimensioned and configured for receiving and securing a corresponding portion of the first cover section 120,220, and other first cover sections. The at least one suction cup 362,362′ permits the first securing or mounting device 360 to be adjustable vertically (upward or downward relative to a first securing or mounting position) and also laterally (rightward or leftward relative to the first securing or mounting position) along the door DR (or a side or wall adjacent to the door).

When the first securing or mounting device 360 is oriented such that the longer portion 361 (compared to the shorter portion 361′) of the first securing or mounting device 360 is positioned closer to the door DR, the door DR and first cover section 120,220, and other first cover sections will be generally closer to one another, due to presence of lesser number of securing slots 364′, to accommodate, for example, a larger food container CONT. Alternatively, when the first securing or mounting device 360 is oriented such that the shorter portion 361′ (compared to the longer portion 361) of the first securing or mounting device 360 is positioned closer to the door DR, the door DR and first cover section 120,220, and other first cover sections will be generally farther to one another, due to presence of greater number of securing slots 364, to accommodate, for example, a smaller food container CONT.

The second securing or mounting device 380 comprises an “L-shaped” configuration having a longer portion 381 and a shorter portion 381′. Each of the longer portion 381 and shorter portion 381′ has a first or back wall securing portion 382,382′, a second or second cover section securing portion 384,384′, and a body 386,386′ disposed between or among the securing portions 382,382′ and 384,384′, respectively. The first securing portion 382,382′ includes at least one suction cup 382,382′ (preferably a pair of magnets 382,382′; not shown but would be located at the applicable locations), and the second securing portion 384,384′ is a plurality of securing slots 384,384′ that is dimensioned and configured for receiving and securing a corresponding portion of the second cover section 140,240, and other second cover sections. The at least suction cup 382,382′ permits the second securing or mounting device 380 to be adjustable vertically (upward or downward relative to a first securing or mounting position) and also laterally (rightward or leftward relative to the first securing or mounting position) along the back wall BW (or a side or wall adjacent to the back wall BW).

When the second securing or mounting device 380 is oriented such that the longer portion 381 (compared to the shorter portion 381′) of the second securing or mounting device 380 is positioned closer to the back wall BW, the back wall BW and second cover section 140,240, and other second cover sections will be generally closer to one another, due to presence of lesser number of securing slots 384′, to accommodate, for example, a larger food container CONT. Alternatively, when the second securing or mounting device 380 is oriented such that the shorter portion 381′ (compared to the longer portion 381) of the second securing or mounting device 380 is positioned closer to the back wall BW, the back wall BW and second cover section 140,240, and other second cover sections will be generally farther to one another, due to presence of greater number of securing slots 384, to accommodate, for example, a smaller food container CONT.

FIG. 20 shows each of the first securing or mounting device 160b and second securing or mounting device 180b being a suction-type securing or mounting device (also as shown in FIGS. 8-10). The suction cups 162b,162b′, 182b,182b′ are not shown but would be located at the applicable locations.

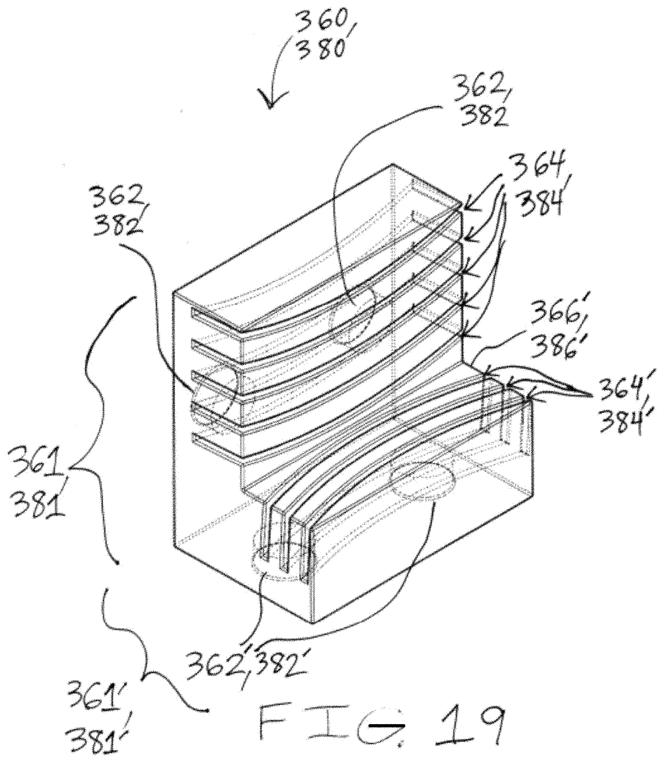

In a non-limiting, third embodiment (as shown in FIGS. 21-24) of the present invention, the splatter cover apparatus 300 is comprised of a two-piece, splatter cover 310 (which is nicknamed the “ying yang cover”), a first securing or mounting device 160a,360, and a second securing or mounting device 180a,380.

The two-piece, splatter cover 310 is comprised of a first or door cover section 320 and a second or back wall cover section 340, and is dimensioned and configured as a one-piece unit, when the first cover section 320 and second cover section 340 come together or toward one another for use, to sufficiently and effectively cover foods and drinks during use (heating or defrosting) such that food and drink splatters are minimized or prevented inside a microwave oven OV. In this non-limiting, third embodiment, the first cover section 320 and second cover section 340 are preferably substantially similar to or exactly the same as one another.

The first or door cover section 320 preferably has both a first cover section height 320h and a first cover section diameter 320d. As a non-limiting example, the first cover section 320 preferably includes a top 322 having a perimeter 324, an engagement surface or area 326, and a plurality of vent holes or apertures 327, and also includes a sidewall 328 extending downward from the perimeter 324 of the top 322. The top 322 has a boot configuration.

The first cover section 320 is capable of being detachably attached, secured or mounted in proximity or the vicinity of a first side or wall, such as the door DR (or a side or wall adjacent to the door DR), of the interior INT of the microwave oven OV by the first securing or mounting device 160a at a securing or mounting height with respect to a bottom side BS of the interior INT of the microwave oven OV.

The second or back wall cover section 340 preferably has both a second cover section height 340h and a second cover section diameter 340d. As a non-limiting example, the second cover section 340 includes a top 342 having a perimeter 344, an engagement surface or area 346, and a plurality of vent holes or apertures 347, and also includes a sidewall 348 extending downward from the perimeter 344 of the top 342. The top 342 has a boot configuration such that the top 322 and top 342 form an oblong round rectangle configuration when they come together or toward one another to operationally form the two-piece, splatter cover 310.

The second cover section 340 is capable of being detachably attached, secured or mounted in proximity or the vicinity of a second side or wall, such as the back wall BW (or a side or wall adjacent to the back wall BW and also opposite to the side or wall that is adjacent to the door DR), of the interior INT of the microwave oven OV by the second securing or mounting device 180a at a securing or mounting height with respect to the bottom side BS of the interior INT of the microwave oven OV.

As a non-limiting example of securing or mounting devices and as shown in FIG. 21, the first securing or mounting device and second securing or mounting device of this third embodiment are previously described and previously shown (FIGS. 1-7) first securing or mounting device 160a and second securing or mounting device 180a, respectively.

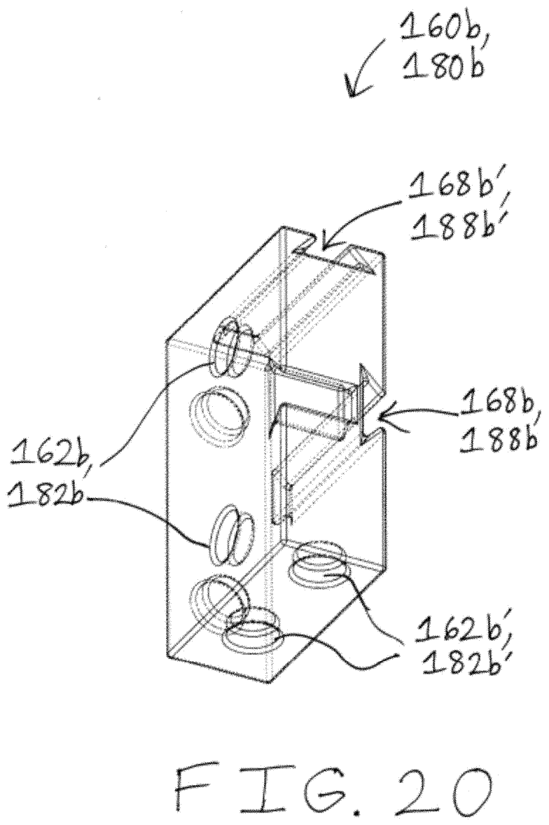

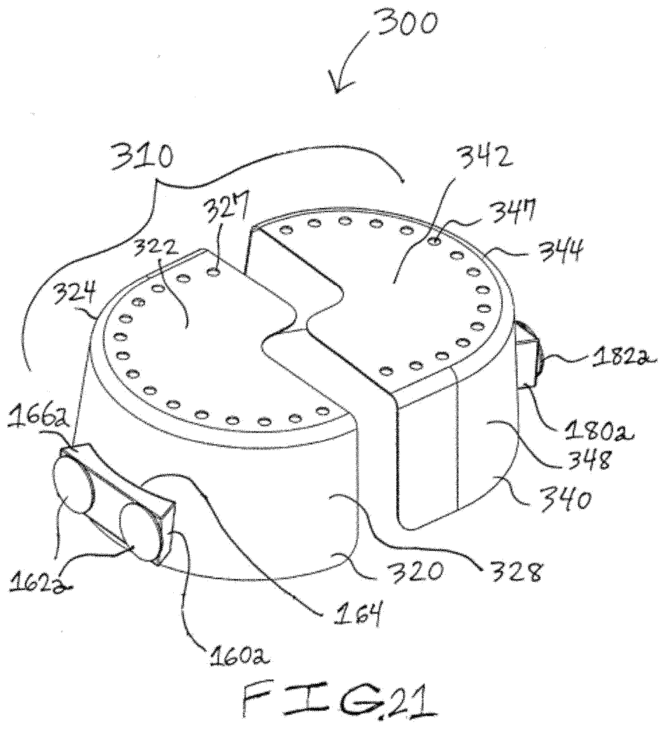

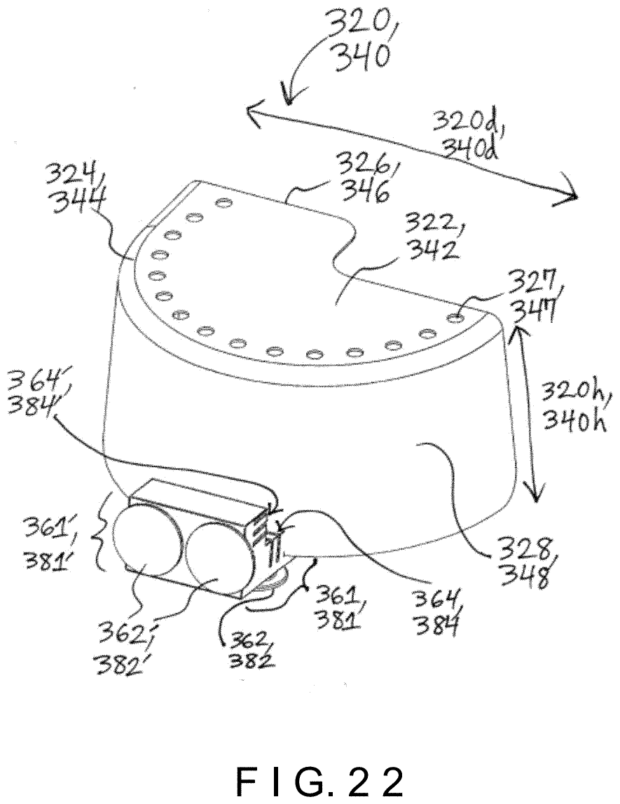

As another non-limiting example of securing or mounting devices and as shown in FIGS. 22-24, the first securing or mounting device and second securing or mounting device of this third embodiment are previously described and previously shown (FIG. 19) first securing or mounting device 360 and second securing or mounting device 380, respectively.

In a non-limiting, fourth embodiment (as shown in FIGS. 25-33) of the present invention, the splatter cover apparatus 400 is comprised of a two-piece, splatter cover 410 (which is nicknamed the “smaller plus larger cover”), a first securing or mounting device 160a, and a second securing or mounting device 180a.

The two-piece, splatter cover 410 is comprised of a first, door or smaller cover section 420 and a second, back wall or larger cover section 440, and is dimensioned and configured as a one-piece, overlapping unit, when the first cover section 420 and second cover section 440 come together for use, to sufficiently and effectively cover foods and drinks during use (heating or defrosting) such that food and drink splatters are minimized or prevented inside a microwave oven OV. In this non-limiting, fourth embodiment, the first cover section 420 fits under and substantially inside the second cover section 440.

The first or smaller cover section 420 preferably has both a first cover section height 420h, a first cover section diameter 420d, and a first cover section length 4201. As a non-limiting example, the first cover section 420 preferably includes a top 422 having a perimeter 424, an end surface or area 426, and a plurality of vent holes or apertures 427, and also includes a sidewall 428 extending downward from the perimeter 424 of the top 422. The top 422 has a half-circle or semi-circle configuration.

The first cover section 420 is capable of being detachably attached, secured or mounted in proximity or the vicinity of a first side or wall, such as the door DR (or a side or wall adjacent to the door DR), of the interior INT of the microwave oven OV by the first securing or mounting device 160a at a securing or mounting height with respect to a bottom side BS of the interior INT of the microwave oven OV.

The second, back wall or larger cover section 440 preferably has both a second cover section height 440h, a second cover section diameter 440d, and a second cover section length 4401. The second cover section height 440h is sufficiently greater than the first cover section height 420h, the second cover section diameter 440d is sufficiently greater than the first cover section diameter 420d, and the second cover section length 4401 is sufficiently greater than the first cover section length 4201 such that the first cover section 420 fits under and substantially inside the second cover section 440 during use.

As a non-limiting example, the second cover section 440 includes a top 442 having a perimeter 444, an end surface or area 446, and a plurality of vent holes or apertures 447, and also includes a sidewall 448 extending downward from the perimeter 444 of the top 442. The top 442 has a semi-oblong rectangular circle configuration such that the first cover section 420 fits under and substantially inside the second cover section 440 when they come toward one another to operationally form the two-piece, splatter cover 410.

The second or larger cover section 440 is capable of being detachably attached, secured or mounted in proximity or the vicinity of a second side or wall, such as the back wall BW (or a side or wall adjacent to the back wall BW and also opposite to the side or wall that is adjacent to the door DR), of the interior INT of the microwave oven OV by the second securing or mounting device 180a at a securing or mounting height with respect to the bottom side BS of the interior INT of the microwave oven OV.

As a non-limiting example of securing or mounting devices and as shown in FIGS. 25-32, the first securing or mounting device and second securing or mounting device of this third embodiment are previously described and previously shown (FIGS. 1-7) first securing or mounting device 160a and second securing or mounting device 180a, respectively.

In a non-limiting, fifth embodiment (as shown in FIGS. 34-39) of the present invention, the splatter cover apparatus 500 is comprised of a four-piece, splatter cover 510, a first securing or mounting device 160a, and a second securing or mounting device 180a.

The four-piece, splatter cover 510 is comprised of a first or door cover section 520, a second or back wall cover section 540, and a pair of extensions 560,580, and is dimensioned and configured as a one-piece unit, when the first cover section 520 and second cover section 540 come together or toward one another for use (especially when the pair of extensions 560,580 are engaged with the first cover section 520 and second cover section 540), to sufficiently and effectively cover foods and drinks during use (heating or defrosting) such that food and drink splatters are minimized or prevented inside a microwave oven OV. In this non-limiting, fifth embodiment, the first cover section 520 and second cover section 540 are preferably substantially similar to or exactly the same as one another (and preferably, substantially similar to or exactly the same as the first cover section 120 and second cover section 140 of the first embodiment), and the extensions 560,580 are substantially similar to or exactly the same as one another.

The first or door cover section 520 preferably has both a first cover section height 520h and a first cover section diameter 520d. As a non-limiting example, the first cover section 520 preferably includes a top 522 having a perimeter 524, an engagement surface or area 526, and a plurality of vent holes or apertures 527, and also includes a sidewall 528 extending downward from the perimeter 524 of the top 522 and a flange 529 extending outward from the bottom of the sidewall 528. The top 522 has a semi-circle or half-circle configuration.

The first cover section 520 is capable of being detachably attached, secured or mounted in proximity or the vicinity of a first side or wall, such as the door DR (or a side or wall adjacent to the door DR), of the interior INT of the microwave oven OV by the first securing or mounting device 160a at a securing or mounting height with respect to a bottom side BS of the interior INT of the microwave oven OV.

The second or back wall cover section 540 preferably has both a second cover section height 540h and a second cover section diameter 540d. As a non-limiting example, the second cover section 540 includes a top 542 having a perimeter 544, an engagement surface or area 546, and a plurality of vent holes or apertures 547, and also includes a sidewall 548 extending downward from the perimeter 544 of the top 542 and a flange 549 extending outward from the bottom of the sidewall 548. The top 542 has a semi-circle or half-circle configuration such that the top 522 and top 542 form a circle configuration when they come together or toward one another to operationally form the three-piece, splatter cover 510.

The second cover section 540 is capable of being detachably attached, secured or mounted in proximity or the vicinity of a second side or wall, such as the back wall BW (or a side or wall adjacent to the back wall BW and also opposite to the side or wall that is adjacent to the door DR), of the interior INT of the microwave oven OV by the second securing or mounting device 180a at a securing or mounting height with respect to the bottom side BS of the interior INT of the microwave oven OV.

As shown in FIGS. 34, 35 and 37, each of the extensions 560,580 is preferably positioned opposite one another and near the corresponding engagement surface or area 526,546 such that the extensions 560,580 can be used for substantially or entirely covering an operational vent gap or distance between the first cover section 520 and second cover section 540 when the first cover section 520 and second cover section 540 are positioned adjacent to one another for use or operation.

As a non-limiting example of securing or mounting devices and as shown in FIGS. 1-7 and 34-39, each of the first securing or mounting device 160a and second securing or mounting device 180a is a suction-type securing or mounting device. Preferably, the first securing or mounting device 160a and second securing or mounting device 180a are substantially similar to or exactly the same as one another.

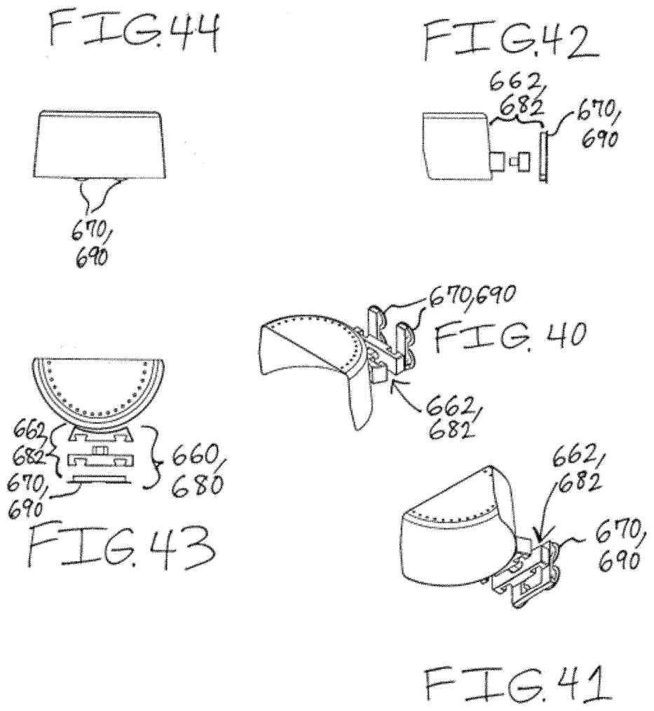

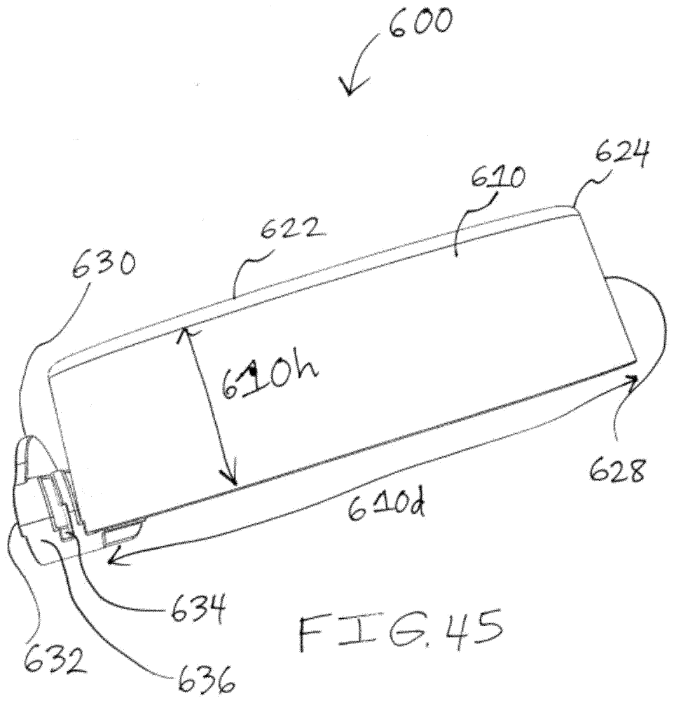

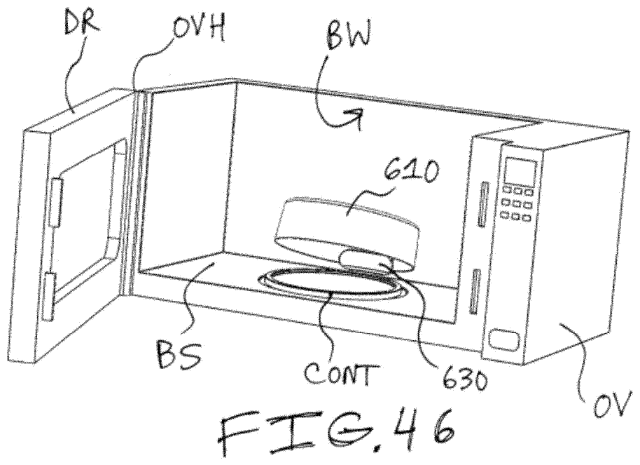

As a further non-limiting example of securing or mounting devices and as shown in FIGS. 40-44, each of the first securing or mounting device 660 and second securing or mounting device 680 is a device with an adjustable bracket system 662,682 and at least one (preferably more than one) suction 670,690. Preferably, the first securing or mounting device 660 and second securing or mounting device 680 are substantially similar to or exactly the same as one another.

In a non-limiting, sixth embodiment (as shown in FIGS. 45-47 and 51-52) of the present invention, the splatter cover apparatus 600 is comprised of a one-piece, splatter cover 610 and a securing or mounting device 630.

The one-piece, splatter cover 610 is dimensioned and configured to sufficiently and effectively cover foods and drinks during use (heating or defrosting) such that food and drink splatters are minimized or prevented inside a microwave oven OV. The splatter cover 610 has both a cover height 610h and a cover diameter 610d. The splatter cover 610 includes a top 622 having a perimeter 624, and also includes a sidewall 628 extending downward from the perimeter 624 of the top 622. The top 622 has a round or circle configuration.

The splatter cover 610 is capable of being detachably attached, secured or mounted in proximity or the vicinity of a side or wall, such as the back wall BW (or a side or wall adjacent to the back wall BW), of the interior INT of the microwave oven OV by the securing or mounting device 630 at a securing or mounting height with respect to the bottom side BS of the interior INT of the microwave oven OV.

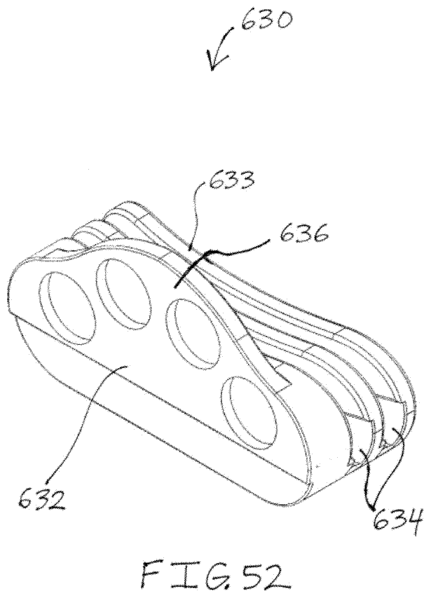

As best shown in FIGS. 51-52, the securing or mounting device 630 comprises a first or back wall securing portion 632, a front wall securing portion 633, a cover securing portion 634, and a body 636 disposed between or among the back wall securing portion 632 and cover securing portion 634. The back wall securing portion 632 may be attached, secured or mounted to a corresponding portion of the back wall BW or side wall by any method, device or feature known to one of ordinary skill in the art, such as, but not limited to, adhesive or suction(s). Preferably, the suction(s) permits/permit the securing or mounting device 630 to be adjustable vertically (upward or downward relative to a first securing or mounting position) and also laterally (rightward or leftward relative to the first securing or mounting position) along the back wall BW (or a side or wall adjacent to the back wall BW). The cover securing portion 634 is preferably at least one (preferably more than one) receiving slot 634 dimensioned and configured for receiving a corresponding portion of the splatter cover 610. Preferably, each of the receiving slots 634 is dimensioned and configured to permit the retained corresponding portion of the splatter cover 610 to be moved rearward at an angle a sufficient amount so that the splatter cover 610 can be raised a sufficient amount of height for accommodating a food container CONT containing food and/or drink and then also to permit the retained corresponding portion of the splatter cover 610 to be moved forward at an angle a sufficient amount so that the splatter cover 610 can be lowered a sufficient amount of height for covering the food container CONT containing food and/or drink prior to use.

In a non-limiting, seventh embodiment (as shown in FIGS. 48-50) of the present invention, the splatter cover apparatus 700 is comprised of a one-piece, splatter cover 710, a securing or mounting device 730, and a stopper 750.

The one-piece, splatter cover 710 is dimensioned and configured to sufficiently and effectively cover foods and drinks during use (heating or defrosting) such that food and drink splatters are minimized or prevented inside a microwave oven OV. The splatter cover 710 has both a cover height 710h and a cover diameter 710d. The splatter cover 710 includes a top 722 having a perimeter 724, and also includes a sidewall 728 extending downward from the perimeter 724 of the top 722. The top 722 has a round or circle configuration.

The splatter cover 710 is capable of being detachably attached, secured or mounted in proximity or the vicinity of a side or wall, such as the back wall BW (or a side or wall adjacent to the back wall BW), of the interior INT of the microwave oven OV by the securing or mounting device 730 at a securing or mounting height with respect to the bottom side BS of the interior INT of the microwave oven OV.

The securing or mounting device 730 comprises a first or back wall securing portion 732, a second or cover securing portion 734, and a body 736 disposed between or among the securing portions 732 and 734. The first securing portion 732 may be attached, secured or mounted to a corresponding portion of the back wall BW or side wall by any method, device or feature known to one of ordinary skill in the art, such as, but not limited to, adhesive or suction(s). Preferably, the suction(s) permits/permit the securing or mounting device 730 to be adjustable vertically (upward or downward relative to a first securing or mounting position) and also laterally (rightward or leftward relative to the first securing or mounting position) along the back wall BW (or a side or wall adjacent to the back wall BW). The second securing or mounting portion 734 is preferably at least one (preferably more than one) receiving slot 734 dimensioned and configured for receiving a corresponding portion of the splatter cover 710. Preferably, each of the receiving slots 734 is dimensioned and configured to permit the retained corresponding portion of the splatter cover 710 to be moved rearward at an angle a sufficient amount so that the splatter cover 710 can be raised a sufficient amount of height for accommodating a food container CONT containing food and/or drink and then also to permit the retained corresponding portion of the splatter cover 710 to be moved forward at an angle a sufficient amount so that the splatter cover 710 can be lowered a sufficient amount of height for covering the food container CONT containing food and/or drink prior to use.

The stopper 750 comprises a first or door securing portion 752, a second or cover engagement portion 754, and a body 756 disposed between or among the door securing portion 752 and the cover engagement portion 754. The door securing portion 752 may be attached, secured or mounted to a corresponding portion of the door DR by any method, device or feature known to one of ordinary skill in the art, such as, but not limited to, adhesive or suction(s). Preferably, the suction(s) permit the stopper 750 to be adjustable vertically (upward or downward relative to a first securing or mounting position) and also laterally (rightward or leftward relative to the first securing or mounting position) along the door DR (or a side or wall adjacent to the door DR). The cover engagement portion 754 is dimensioned and configured for engaging with a corresponding portion of the splatter cover 710 such that the splatter cover 710 is positioned generally below the stopper 750 during use or operation.

It is preferred that any of the securing or mounting devices (with or without at least one water reservoir) of the present invention and that are disclosed in the application may be used with any of the cover sections (first cover section, second cover section, and whole cover section; with or without at least one water reservoir) of the present invention and disclosed in the application. As a non-limiting example or embodiment, any of the cover sections can have a mounting “block” or securing device, such as, but not limited to, 160a,180a, permanently attached to the cover section. The mounting “blocks” or securing device of the cover sections may be pressed against the microwave oven back wall BW and door DR allowing the “blocks” and attached cover sections to stay in place via suction cups, magnets, or other attachment means.

As another non-limiting example or embodiment, the mounting “blocks” or securing devices with channels or receiving slots (such as, but not limited to, 360,380 with 364,384,364′,384′) hold the cover sections or halves in place. The cover sections or halves can be easily removed from the channels or receiving slots 364,384,364′,384′. Mounting “blocks” or securing devices 360,380 have multiple channels or receiving slots 364,384,364′,384′ to accommodate mounting in different size microwave ovens. The mounting “blocks” or securing devices 360,380 can include different mounting geometry to allow one block to accommodate large, medium and small microwave ovens. The mounting “blocks” or securing devices 360,380 may mount in more than one way to the inside of the microwave oven allowing for one block design to be used for different microwave ovens.

As a further non-limiting example or embodiment, the mounting means is preferably via suction cup or suctions cups. Other mounting systems using magnets, hook and loop fasteners, adhesives or other means may be used. The mounting system for the door-mounted cover section may be placed over the microwave door DR. The mounting cover on the back wall BW may be mounted via a mechanical mechanism such as telescoping legs that are held in place via internal springs that connect to the internal side walls or the microwave oven OV or roof and floor of the microwave wave OV.

As an additional non-limiting example or embodiment, the mounting “blocks” or securing devices may include channels that mate up to covers with complimentary structures on the cover sections. The mounting “blocks” or securing devices may also include shafts or tabs that allow the mounting system to telescope. The telescoping parts allow the mounting system dimensions to be changed to accommodate different microwave oven sizes.

As another additional non-limiting example or embodiment, the split microwave oven cover (such as, but not limited to, 110) may also be held in place via mounts that are installed as part of a microwave oven's structure when manufactured at a factory.

As a further non-limiting example or embodiment, the split covers (such as, but not limited to, 110) are designed to have enough height to provide clearance over mugs that are placed inside the microwave oven OV. This allows the covers to be used with both plates and mugs unlike most conventional microwave splatter covers.

Preferably, the brackets that go onto the wall (such as, but not limited to, BW) and door DR of the microwave oven OV may be attached or secured by any of the following devices or methods: suction cups, magnets, silicone rubber pads (or other type of elastomeric material) that adhere to smooth surfaces (and therefore act like suction cups), hook and loop fastener (held in place via adhesive backings), adhesive/glue, adhesive pads, and double-sided tapes or foam. The brackets that go onto the wall (such as, but not limited to, BW) and door DR of the microwave oven OV may also be attached or secured by any device or method known to one of ordinary skill in the art.

As non-limiting examples, the suction cups and magnets (or other attachment device) may be in quantities of one, two, three, four or more on each side/cover or bracket. The silicone rubber pad for instance may cover the whole of the bracket that attaches to the wall (such as, but not limited to, BW) and door DR.

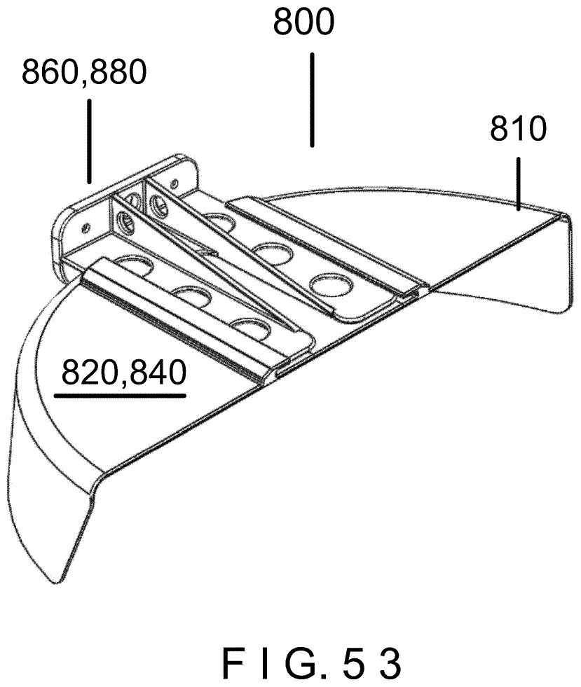

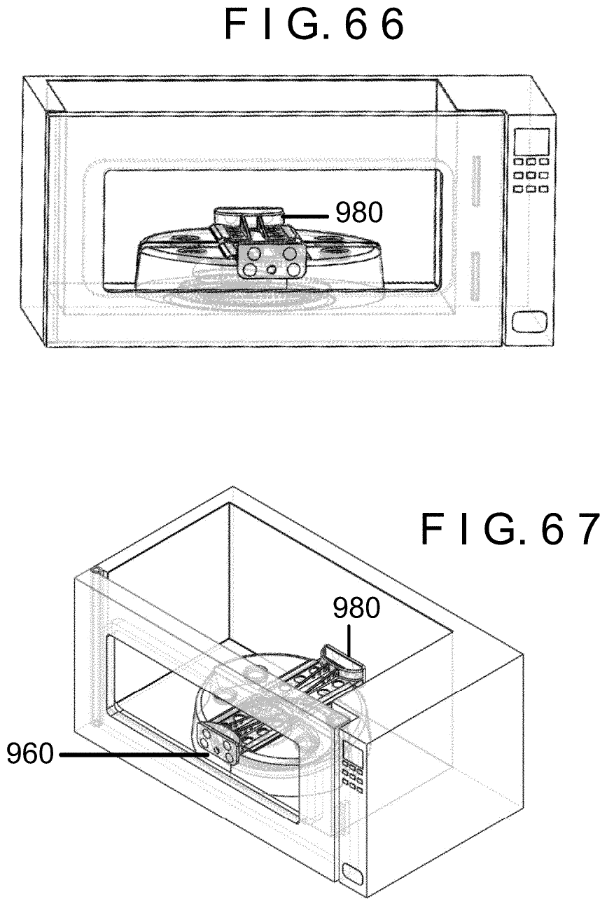

In a further, non-limiting embodiment (as shown in FIGS. 53-56) of the present invention, the splatter cover apparatus 800 is preferably comprised of a two-piece, splatter cover 810 (which is nicknamed the “rails cover”), a first securing or mounting device 860, and a second securing or mounting device 880. The splatter cover apparatus 800, which is not shown in any environmental view(s), is preferably substantially similar to splatter cover apparatus 900 (except that the two-piece, splatter cover 910 of the splatter cover apparatus 900 has at least one water reservoir while the two-piece, splatter cover 810 of the splatter cover apparatus 800 does not). The splatter cover apparatus 800 may be secured to a microwave oven OV at or about the positions shown in FIGS. 66-71, which are some environmental view(s) for splatter cover apparatus 900.

As best shown in FIGS. 53-55, the two-piece, splatter cover 810 is comprised of a first or door cover section 820 and a second or back wall cover section 840, and is dimensioned and configured as a one-piece unit when the first cover section 820 and second cover section 840 come together or toward one another for use to sufficiently and effectively cover foods and drinks during use (heating or defrosting) such that food and drink splatters are minimized or prevented inside a microwave oven (not shown in FIGS. 53-56 but shown in many FIGURES in this application). In this non-limiting embodiment, the first cover section 820 and second cover section 840 are preferably substantially similar to or exactly the same as one another.

The first or door cover section 820 preferably has both a first cover section height 820h and a first cover section diameter 820d. As a non-limiting example, the first cover section 820 preferably includes a top 822 having a perimeter 824, an engagement surface or area 826, and at least one rail (preferably a pair of rails 830a,830b) positioned upon the top 822, and also includes a sidewall 828 extending downward from the perimeter 824 of the top 822. The top 822 has a semi-circle or half-circle configuration. Each rail 830a,830b preferably includes a first end 831a,831b, a second end 832a,832b, a body 833a,833b, a top 834a,834b, a sidewall 835a,835b, an open channel 836a,836b, and a length 837a,837b. Each open channel 836a,836b of the corresponding rail 830a,830b is dimensioned and configured for engaging with an applicable portion of the first securing or mounting device 860, and has a length to accommodate the interaction or engagement between the rails 830a,830b and first securing or mounting device 860 in microwave ovens having different distances from the oven door to the back wall or from one side or wall to the opposite side or wall.

The first cover section 820 is capable of being detachably attached, secured or mounted in proximity or the vicinity of a first side or wall, such as the door (or a side or wall adjacent to the oven door), of the interior of the microwave oven by the first securing or mounting device 860 at a securing or mounting height with respect to a bottom side of the interior of the microwave oven.

The second or back wall cover section 840 preferably has both a first cover section height 840h and a first cover section diameter 840d. As a non-limiting example, the second cover section 840 preferably includes a top 842 having a perimeter 844, an engagement surface or area 846, and at least one rail (preferably a pair of rails 850a,530b) positioned upon the top 842, and also includes a sidewall 848 extending downward from the perimeter 844 of the top 842. The top 842 has a semi-circle or half-circle configuration. Each rail 850a,850b preferably includes a first end 851a,851b, a second end 852a,852b, a body 853a,853b, a top 854a,854b, a sidewall 855a,855b, an open channel 856a,856b, and a length 857a,857b. Each open channel 856a,856b of the corresponding rail 850a,850b is dimensioned and configured for engaging with an applicable portion of the second securing or mounting device 880, and has a length to accommodate the interaction or engagement between the rails 850a,850b and second securing or mounting device 880 in microwave ovens having different distances from the oven door to the back wall or from one side or wall to the opposite side or wall.

The second cover section 880 is capable of being detachably attached, secured or mounted in proximity or the vicinity of a second side or wall, such as the back wall (or a side or wall adjacent to the back wall and also opposite to the side or wall that is adjacent to the door), of the interior of the microwave oven by the second securing or mounting device 880 at a securing or mounting height with respect to the bottom side of the interior of the microwave oven.

When the first cover section 820 and second cover section 840 come together or toward one another (not shown) to operationally form the two-piece, splatter cover 810, the engagement surface or area 826 of the first cover section 820 and the engagement surface or area 846 of the second cover section 840 may be separated by a small distance and/or also may be offset with one another that creates a vent operationally while still minimizing or preventing splatters.

As best shown in FIGS. 53, 54 and 56, each of the first securing or mounting device 860 and second securing device 880 is a securing or mounting device that is dimensioned and configured for receiving a corresponding pair of rails 830a,830b,850a,850b of the cover section 820,840 for engagement between the securing or mounting device 860,880 and corresponding cover section 820,840. When there's a desire to disengage the cover section(s) 820,840 from the corresponding securing or mounting device(s) 860,880 (such as for washing or replacement of the cover section(s) 820,840), then the cover section(s) 820,840 may be slid off of the corresponding securing or mounting device(s) 860,880. Preferably, the first securing or mounting device 860 and second securing or mounting device 880 are substantially similar to or exactly the same as one another.

The first securing or mounting device 860 comprises a first or door securing portion 862, a pair of engagement members 866a,866b (with preferably apertures or holes 867a,867b; extend forwardly and generally horizontally from the first or door securing portion 862), and a pair of securing members 868a,868b (with preferably apertures or holes 869a,869b; extend upwardly and generally vertically from the pair of engagement members 866a,866b). Preferably, the first or door securing portion 862 is generally planar, and is dimensioned and configured for securing the first securing or mounting device 860 to the door (or a side or wall adjacent to the door) of a microwave oven. Each of the pair of engagement members 866a,866b is dimensioned and configured for engaging with the corresponding rail 830a,830b of the cover section 820. The apertures or holes 867a,867b,869a,869b help to reduce materials needed to manufacture the first securing or mounting device 860.

The second securing or mounting device 880 comprises a second or back wall securing portion 882, a pair of engagement members 886a,886b (with preferably apertures or holes 887a,887b; extend forwardly and generally horizontally from the second or back wall securing portion 882), and a pair of securing members 888a,888b (with preferably apertures or holes 889a,889b; extend upwardly and generally vertically from the pair of engagement members 886a,866b). Preferably, the second or back wall securing portion 882 is generally planar, and is dimensioned and configured for securing the second securing or mounting device 880 to the back wall (or a side or wall adjacent to the back wall) of a microwave oven. Each of the pair of engagement members 886a,886b is dimensioned and configured for engaging with the corresponding rail 850a,850b of the cover section 840. The apertures or holes 887a,887b,889a, 889b help to reduce materials needed to manufacture the second securing or mounting device 880.

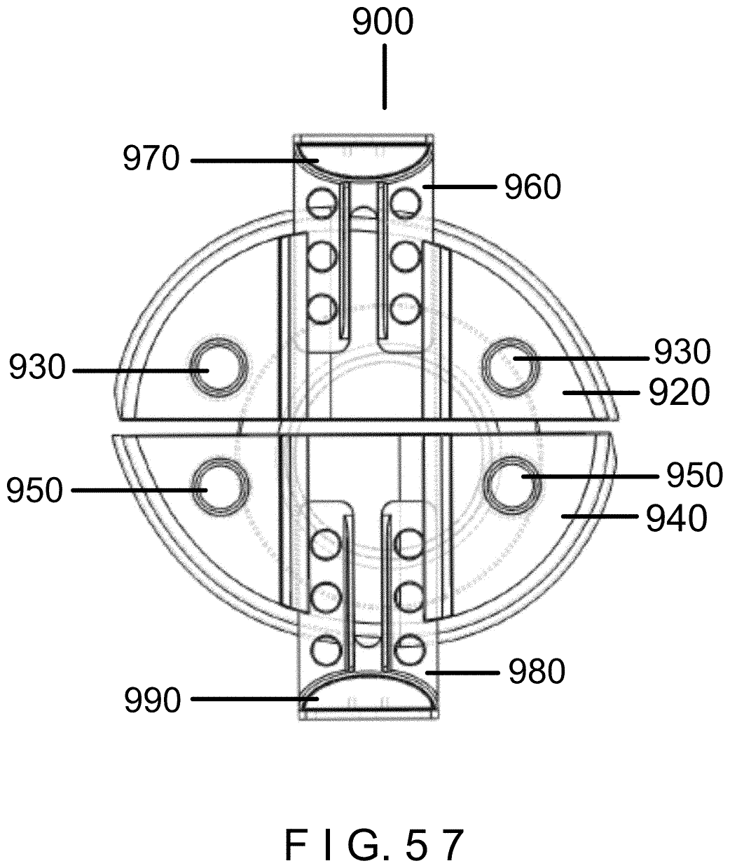

In another, non-limiting embodiment (as shown in FIGS. 57-73) of the present invention, the splatter cover apparatus 900 is preferably comprised of a two-piece, splatter cover 910 (which is nicknamed the “moisture-creating cover”) having at least one water reservoir, a first securing or mounting device 960, and a second securing or mounting device 980. The splatter cover apparatus 900 is preferably substantially similar to splatter cover apparatus 800 (except that the two-piece, splatter cover 910 of the splatter cover apparatus 900 has at least one water reservoir (on either of both of the first or door cover section 920 and second or back wall cover section 940) while the two-piece, splatter cover 810 of the splatter cover apparatus 800 does not).

The two-piece, splatter cover 910 is comprised of a first or door cover section 920 and a second or back wall cover section 940, and is dimensioned and configured generally as a one-piece unit, when the first cover section 920 and second cover section 940 come together or toward one another (preferably, with a small space or gap distance between them to allow the created moisture from the fluid in the water reservoir(s) to make contact with the food and provide the food with some moisture during use) for use, to sufficiently and effectively cover foods and drinks during use (heating or defrosting) such that food and drink splatters are minimized or prevented inside a microwave oven OV while also providing some additional moisture to the food. In addition to or alternative to the small space or gap distance between the first cover section 920 and second cover section 940 (when they are brought toward one another), one or both of the first cover section 920 and second cover section 940 may include at least one aperture or hole (not shown in this embodiment but shown in some of the other embodiments previously disclosed and described in this application) dimensioned and configured in the top and/or the sidewall to allow the created moisture from the fluid in the water reservoir(s) to make contact with the food and provide the food with some moisture during use. In this further, non-limiting embodiment, the first cover section 920 and second cover section 940 are preferably substantially similar to or exactly the same as one another. At least one of the first cover section 920 and second cover section 940 has at least one water reservoir for creating moisture for foods during use inside a microwave oven, but it is preferred that each of the first cover section 920 and second cover section 940 has at least one water reservoir.

The first or door cover section 920 preferably has both a first cover section height 920h and a first cover section diameter 920d. As a non-limiting example, the first cover section 920 preferably includes a top 922 having a perimeter 924, an engagement surface or area 926, at least one rail (preferably a pair of rails 930a,930b) positioned upon the top 922, at least one water reservoir (preferably a pair of water reservoirs 938a,938b) positioned upon and/or within the top 922, and at least one reservoir cover (preferably a pair of reservoir covers 939a,939b with holes or apertures), and also includes a sidewall 928 extending downward from the perimeter 924 of the top 922. The top 922 has a semi-circle or half-circle configuration. Each rail 930a,930b preferably includes a first end 931a,931b, a second end 932a,932b, a body 933a,933b, a top 934a,934b, a sidewall 935a,935b, an open channel 936a,936b, and a length 937a,937b. Each open channel 936a,936b of the corresponding rail 930a,930b is dimensioned and configured for engaging with an applicable portion of the first securing or mounting device 960, and has a length to accommodate the interaction or engagement between the rails 930a,930b and first securing or mounting device 960 in microwave ovens having different distances from the oven door to the back wall or from one side or wall to the opposite side or wall. Preferably, each water reservoir 938a,938b is dimensioned and configured to receive a fluid (such as, but not limited to, water) and/or a solid (such as, but not limited to, ice) that is/are able to create moisture for the food and/or drink being microwaved during use of the apparatus 900 in a microwave oven OV. Preferably, each reservoir cover 939a,939b is dimensioned and configured to engage with and cover the corresponding water reservoir 938a,938b, and includes holes or apertures to allow moisture and steam to flow out or escape from of the water reservoir 938a,938b during use and create some moisture for the food and/or drink being microwaved.

The first cover section 920 is capable of being detachably attached, secured or mounted in proximity or the vicinity of a first side or wall, such as the door DR (or a side or wall adjacent to the door DR), of the interior INT of the microwave oven OV by the first securing or mounting device 960 at a securing or mounting height with respect to a bottom side BS of the interior INT of the microwave oven OV.

The second or back wall cover section 940 preferably has both a first cover section height 940h and a first cover section diameter 940d. As a non-limiting example, the second cover section 940 preferably includes a top 942 having a perimeter 944, an engagement surface or area 946, at least one rail (preferably a pair of rails 950a,950b) positioned upon the top 942, at least one water reservoir (preferably a pair of water reservoirs 958a,958b) positioned upon and/or within the top 942, and at least one reservoir cover (preferably a pair of reservoir covers 959a,959b with holes or apertures), and also includes a sidewall 948 extending downward from the perimeter 944 of the top 942. The top 942 has a semi-circle or half-circle configuration. Each rail 950a,950b preferably includes a first end 951a,951b, a second end 952a,952b, a body 953a,953b, a top 954a,954b, a sidewall 955a,955b, an open channel 956a,956b, and a length 957a,957b. Each open channel 956a,956b of the corresponding rail 950a,950b is dimensioned and configured for engaging with an applicable portion of the second securing or mounting device 980, and has a length to accommodate the interaction or engagement between the rails 950a,950b and second securing or mounting device 980 in microwave ovens OV having different distances from the oven door DR to the back wall BW or from one side or wall to the opposite side or wall. Preferably, each water reservoir 958a,958b is dimensioned and configured to receive a fluid (such as, but not limited to, water) and/or a solid (such as, but not limited to, ice) that is/are able to create moisture for the food and/or drink being microwaved during use of the apparatus 900 in a microwave oven OV. Preferably, each reservoir cover 959a,959b is dimensioned and configured to engage with and cover the corresponding water reservoir 958a,958b, and includes holes or apertures to allow moisture to flow out of or escape from the water reservoir 958a,958b during use and create some moisture for the food and/or drink being microwaved.

The second cover section 980 is capable of being detachably attached, secured or mounted in proximity or the vicinity of a second side or wall, such as the back wall BW (or a side or wall adjacent to the back wall BW and also opposite to the side or wall that is adjacent to the door DR), of the interior of the microwave oven OV by the second securing or mounting device 980 at a securing or mounting height with respect to the bottom side BS of the interior of the microwave oven OV.

As best shown in FIGS. 57, 66, 67, and 69-71, when the first cover section 920 and second cover section 940 come together or toward one another to operationally form the two-piece, splatter cover 910, the engagement surface or area 926 of the first cover section 920 and the engagement surface or area 946 of the second cover section 940 may be separated by a small distance and/or also may be offset with one another that creates a vent operationally while still minimizing or preventing splatters.

As best shown in FIGS. 57-60 and 63-65, each of the first securing or mounting device 960 and second securing device 980 is a securing or mounting device that is dimensioned and configured for receiving a corresponding pair of rails 930a,930b,950a,950b of the cover section 920,940 for engagement between the securing or mounting device 960,980 and corresponding cover section 920,940. When there's a desire to disengage the cover section(s) 920,940 from the corresponding securing or mounting device(s) 960,980 (such as for washing or replacement of the cover section(s) 920,940), then the cover section(s) 920,940 may be slid off of the corresponding securing or mounting device(s) 960,980. Preferably, the first securing or mounting device 960 and second securing or mounting device 980 are substantially similar to or exactly the same as one another.

The first securing or mounting device 960 comprises a first or door securing portion 962, a pair of engagement members 966a,966b (with preferably apertures or holes 967a,967b; extend forwardly and generally horizontally from the first or door securing portion 962), a pair of securing members 968a,968b (with preferably apertures or holes 969a,969b; extend upwardly and generally vertically from the pair of engagement members 966a,966b), at least one water reservoir (preferably, one water reservoir 978) positioned adjacent the first or door securing portion 962 and pair of engagement members 966a,966, and at least one reservoir cover (preferably, one reservoir cover 979 with holes or apertures). Preferably, the first or door securing portion 962 is generally planar, and is dimensioned and configured for securing the first securing or mounting device 960 to the door DR (or a side or wall adjacent to the door DR) of a microwave oven OV. Each of the pair of engagement members 966a,966b is dimensioned and configured for engaging with the corresponding rail 930a,930b of the cover section 920. The apertures or holes 967a,967b,969a, 969b help to reduce materials needed to manufacture the first securing or mounting device 960. Preferably, the water reservoir 978 is dimensioned and configured to receive a fluid (such as, but not limited to, water) and/or a solid (such as, but not limited to, ice) that is/are able to create moisture for the food and/or drink being microwaved during use of the apparatus 900 in a microwave oven OV. Preferably, the reservoir cover 979 is dimensioned and configured to engage with and cover the water reservoir 978, and includes holes or apertures to allow moisture and steam to flow out of or escape from the water reservoir 978 during use and create some moisture for the food and/or drink being microwaved.

The second securing or mounting device 980 comprises a second or back wall securing portion 982, a pair of engagement members 986a,986b (with preferably apertures or holes 987a,987b; extend forwardly and generally horizontally from the second or back wall securing portion 982), a pair of securing members 988a,988b (with preferably apertures or holes 989a,989b; extend upwardly and generally vertically from the pair of engagement members 986a,986b), at least one water reservoir (preferably, one water reservoir 998) positioned adjacent the second or back wall securing portion 982 and pair of engagement members 986a,986, and at least one reservoir cover (preferably, one reservoir cover 999 with holes or apertures). Preferably, the second or back wall securing portion 982 is generally planar, and is dimensioned and configured for securing the second securing or mounting device 980 to the back wall BW (or a side or wall adjacent to the back wall BW) of a microwave oven OV. Each of the pair of engagement members 986a,986b is dimensioned and configured for engaging with the corresponding rail 950a, 950b of the cover section 940. The apertures or holes 987a,987b,989a,989b help to reduce materials needed to manufacture the second securing or mounting device 980. Preferably, the water reservoir 998 is dimensioned and configured to receive a fluid (such as, but not limited to, water) and/or a solid (such as, but not limited to, ice) that is/are able to create moisture for the food and/or drink being microwaved during use of the apparatus 900 in a microwave oven OV. Preferably, the reservoir cover 999 is dimensioned and configured to engage with and cover the water reservoir 998, and includes holes or apertures to allow moisture and steam to flow out of or escape from the water reservoir 998 during use and create some moisture for the food and/or drink being microwaved.

In a further, non-limiting embodiment (as shown in FIG. 74) of the present invention, the splatter cover apparatus 1000 is preferably comprised of a two-piece, splatter cover 1010 (which is nicknamed the “moisture-creating and butter-creating cover”) having at least one water reservoir (preferably, one water reservoir 938a,958a on each of the first or door cover section 1020 and second or back wall cover section 1040), at least one butter reservoir (preferably, one butter reservoir 1038b,1058b on each of the first or door cover section 1020 and second or back wall cover section 1040), at least one water reservoir cover with holes or apertures (preferably, one water reservoir cover (not shown but substantially similar to or exactly the same as 939a,959a) for each of the water reservoir 938a,958a), at least one butter reservoir cover without holes or apertures (preferably, one butter reservoir cover (not shown) for each of the butter reservoir 1038b,1058b), a first securing or mounting device 960, and a second securing or mounting device 980. Preferably, the butter reservoir 1038b,1058b has at least one hole dimensioned and configured for allowing melted butter, other meltable food products, and/or even water to drip down onto the food itself and/or a plate, bowl, or cup of food or beverage that is placed beneath the splatter cover 1010. This butter reservoir 1038b,1058b for melting butter, other meltable food products, and/or even water may have a cover without holes (not shown) to prevent the butter and/or other meltable food products from splattering as they melt. To avoid being redundant or repeating a lot of the details regarding splatter cover apparatus 900, only the differences will be described. The splatter cover apparatus 1000 is preferably substantially similar to splatter cover apparatus 900 (except that the two-piece, splatter cover 1010 of the splatter cover apparatus 1000 has at least one butter reservoir 1038b,1058b (on either of both of the first or door cover section 1020 and second or back wall cover section 1040) and at least one butter reservoir cover 1039b,1059b (on either of both of the first or door cover section 1020 and second or back wall cover section 1040) while the two-piece, splatter cover 910 of the splatter cover apparatus 900 does not).

As non-limiting examples, some, most or all of the components of the present invention may be manufactured or made of plastic, glass, any material known to one of ordinary skill in the art, and any combination thereof. Preferably, some, most or all of the components of the present invention may be manufactured or made of a microwave oven safe material (preferably, a microwave oven safe, food safe, and non-toxic material) and/or a dishwasher safe material.

Other non-limiting embodiments of the present invention may include different combination(s) of a first or door cover section, a second or back wall cover section, a first securing or mounting device, and a second securing or mounting device from two or more embodiments described in this application.

It is to be understood that the present invention is not limited to the embodiments and aspects described above or as shown in the attached figures, but encompasses any and all embodiments and aspects within the spirit of the invention.

1. A splatter cover for minimizing or preventing food and drink splatters and for creating moisture for a food during use inside a microwave oven, said splatter cover comprising:
a top comprising a perimeter;
at least one sidewall,
wherein at least one of said top and said at least one sidewall comprises a space dimensioned and configured for allowing created moisture to make contact with the food during use inside the microwave oven;
a height;
a diameter, and
at least one water reservoir dimensioned and configured for receiving a fluid,
wherein heating of the fluid during use inside the microwave oven creates the created moisture.

2. The splatter cover according to claim 1, further comprising at least one butter reservoir and at least one butter reservoir cover, wherein said at least one butter reservoir is dimensioned and configured for receiving butter and/or other meltable food products, and wherein said at least one butter reservoir cover is for covering said at least one butter reservoir during use to prevent splatters from the butter and/or other meltable food products.

3. The splatter cover according to claim 2, wherein said at least one butter reservoir comprises at least one aperture dimensioned and configured for allowing butter and/or or other meltable food products that is melted during use to drip downward toward the food and a container containing the food.

4. The splatter cover according to claim 1, further comprising at least one engagement rail adapted for engaging with a securing or mounting device that is secured to an interior of the microwave oven at a securing height with respect to a bottom side of the interior of the microwave oven.

5. The splatter cover according to claim 1, wherein said space is at least one aperture.

6. The splatter cover according to claim 1, wherein said splatter cover is a two-piece, splatter cover comprising a first cover section and a second cover section,
wherein said first cover section comprises a top, a sidewall, a first cover section height, and a first cover section diameter,
wherein said top of said first cover section comprises a perimeter and an engagement surface or area,
wherein said second cover section comprises a sidewall and a second cover section height, and
wherein said first cover section and said second cover section, when acting as a one-piece unit when said first cover section and said second cover section come together or toward one another for use, are dimensioned and configured to sufficiently and effectively cover foods and drinks during use such that food and drink splatters are minimized or prevented inside the microwave oven.

7. The splatter cover according to claim 6, wherein at least one of said first cover section and said second cover section further comprises at least one butter reservoir and at least one butter reservoir cover, wherein said at least one butter reservoir is dimensioned and configured for receiving butter and/or other meltable food products, and wherein said at least one butter reservoir cover is for covering said at least one butter reservoir during use to prevent splatters from the butter and/or other meltable food products.

8. The splatter cover according to claim 7, wherein said at least one butter reservoir comprises at least one aperture dimensioned and configured for allowing butter and/or or other meltable food products that is melted during use to drip downward toward the food and a container containing the food.

9. The splatter cover according to claim 6, wherein at least one of said first cover section and said second cover section further comprises at least one engagement rail adapted for engaging with a corresponding securing or mounting device that is secured to an interior of the microwave oven at a securing height with respect to a bottom side of the interior of the microwave oven.

10. The splatter cover according to claim 6, wherein said space is at least one aperture.

11. A splatter cover apparatus for minimizing or preventing food and drink splatters and for creating moisture for a food during use inside a microwave oven, said apparatus comprising:
a splatter cover comprising a top, at least one sidewall, a height, and a diameter,
wherein said top comprises a perimeter,
wherein at least one of said top and said at least one sidewall comprises a space dimensioned and configured for allowing created moisture to make contact with the food during use inside the microwave oven; and
at least one securing or mounting device comprising a microwave oven securing or mounting portion and a splatter cover securing portion,
wherein said at least one securing or mounting device is capable of detachably securing or mounting said splatter cover in proximity or vicinity of a corresponding side or wall of an interior of the microwave oven at a securing height with respect to a bottom side of the interior of the microwave oven,
wherein at least one of said splatter cover and said at least one securing or mounting device further comprises at least one water reservoir dimensioned and configured for receiving a fluid, and
wherein heating of the fluid during use inside the microwave oven creates the created moisture that makes contact with the food during use inside the microwave oven.

12. The apparatus according to claim 11, wherein said splatter cover further comprises at least one butter reservoir and at least one butter reservoir cover, wherein said at least one butter reservoir is dimensioned and configured for receiving butter and/or other meltable food products, and wherein said at least one butter reservoir cover is for covering said at least one butter reservoir during use to prevent splatters from the butter and/or other meltable food products.

13. The apparatus according to claim 12, wherein said at least one butter reservoir comprises at least one aperture dimensioned and configured for allowing butter and/or or other meltable food products that is melted during use to drip downward toward the food and a container containing the food.

14. The apparatus according to claim 11, wherein said splatter cover further comprises said at least one water reservoir.

15. The apparatus according to claim 11, wherein said at least one securing or mounting device further comprises said at least one water reservoir.

16. The apparatus according to claim 11, wherein said splatter cover further comprises at least one engagement rail adapted for engaging with a corresponding securing or mounting device of said at least one securing or mounting device.

17. The apparatus according to claim 11, wherein said space is at least one aperture.

18. The apparatus according to claim 11, wherein said splatter cover is a two-piece, splatter cover comprising a first cover section and a second cover section,
wherein said first cover section comprises a top, a sidewall, a first cover section height, and a first cover section diameter,
wherein said top of said first cover section comprises a perimeter and an engagement surface or area,
wherein said second cover section comprises a sidewall and a second cover section height,
wherein said first cover section and said second cover section, when acting as a one-piece unit when said first cover section and said second cover section come together or toward one another for use, are dimensioned and configured to sufficiently and effectively cover foods and drinks during use such that food and drink splatters are minimized or prevented inside the microwave oven,
wherein said at least one securing or mounting device is a first securing or mounting device and a second securing or mounting device,
wherein each of said first securing or mounting device and said second securing or mounting device comprises a microwave oven securing or mounting portion and a splatter cover securing portion, and
wherein each of said first securing or mounting device and said second securing or mounting device is capable of detachably securing or mounting a corresponding cover section of said first cover section and said second cover section in proximity or vicinity of a corresponding side or wall of an interior of the microwave oven at a securing height with respect to a bottom side of the interior of the microwave oven.

19. The apparatus according to claim 18, wherein at least one of said first cover section and said second cover section further comprises at least one butter reservoir and at least one butter reservoir cover, wherein said at least one butter reservoir is dimensioned and configured for receiving butter and/or other meltable food products, and wherein said at least one butter reservoir cover is for covering said at least one butter reservoir during use to prevent splatters from the butter and/or other meltable food products.

20. The apparatus according to claim 19, wherein said at least one butter reservoir comprises at least one aperture dimensioned and configured for allowing butter and/or or other meltable food products that is melted during use to drip downward toward the food and a container containing the food.

21. The apparatus according to claim 18, wherein said space is at least one aperture.

22. A securing or mounting device for creating moisture for a food during use inside a microwave oven, said securing or mounting device comprising:
a microwave oven securing or mounting portion;
a splatter cover securing portion; and
at least one water reservoir dimensioned and configured for receiving a fluid,
wherein heating of the fluid during use inside the microwave oven creates created moisture that makes contact with the food being heated, and
wherein said securing or mounting device is capable of detachably securing or mounting a splatter cover inside the microwave oven at a securing height with respect to a bottom side of an interior of the microwave oven.
